(19) United States
(12) Patent Application Publication
(10) Pub. No.: US 2010/0325633 A1
(43) Pub. Date: Dec. 23, 2010

(54) Searching Regular Expressions With Virtualized Massively Parallel Programmable Hardware

(75) Inventors: Kenneth H. Eguro, Seattle, WA (US); Alessandro Forin, Redmond, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/552,944

(22) Filed: Sep. 2, 2009

Related U.S. Application Data
(60) Provisional application No. 61/218,816, filed on Jun. 19, 2009.

(51) Int. Cl. G06F 9/46

(52) U.S. Cl. 718/103

(57) ABSTRACT

Logic and state information suitable for execution on a programmable hardware device may be generated from a task, such as evaluating a regular expression against a corpus. Hardware capacity requirements of the logic and state information on the programmable hardware device may be estimated. Once estimated, a plurality of the logic and state information generated from a plurality of tasks may be distributed into sets such that the logic and state information of each set fits within the hardware capacity of the programmable hardware device. The tasks within each set may be configured to execute in parallel on the programmable hardware device. Sets may then be executed in series, permitting virtualization of the resources.

### PRIORITY AND RELATED APPLICATION

The present application claims priority to and is related to U.S. Provisional Application Ser. No. 61/218,816, entitled, “Searching Regular Expressions With Virtualized Massively Parallel Programmable Hardware” to Kenneth H. Eguro and Alessandro Forin, filed on Jun. 19, 2009; which is incorporated by reference herein for all that it teaches and discloses.

### BACKGROUND

Regular expression searching is a common operation for a wide variety of applications, ranging from e-mail spam filtering and network intrusion detection to genetic research. A regular expression (“reg ex” or “RE”) provides a concise and flexible means for identifying strings of interest, such as particular characters, words, or patterns of characters. For example, a regular expression of “*car*” when parsing a text file may identify “car,” “cartoon,” “vicar,” etc.

Traditionally, reg exs have been executed using software- or hardware-based search solutions. Unfortunately, these solutions encounter problems when performing a large number of complex searches.

Software-based searching suffers a fundamental problem with throughput. While popular because of their flexibility to perform any number of essentially arbitrarily complex searches, the speed of these processor-based systems scales poorly and inconsistently as the number and complexity of searches are increased. In other words, a reg ex search on a large body of data (“corpus”) becomes impractical.

On the other hand, existing hardware-based searching solutions have a fundamental problem with adaptability. Although these systems can have fast and consistent performance for the searches that can be mapped to them, existing devices have strict limitations in terms of the number and complexity of searches that can be supported without detailed expert knowledge and manual intervention. In other words, hardware searching is fast, but limited.

Thus, there is a compelling need for providing software-like flexibility to hardware-based processing of algorithms such as regular expression searches.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Computational tasks including, but not limited to, regular expressions may be converted into corresponding logic and state equations. The physical resource requirements, such as how much of a programmable hardware device is necessary for execution of the logic and state equations, may be estimated without iterative trial and error through computer-aided design (CAD) tools. Once estimated, the computational tasks may be distributed into sets, where each set fits within the individual available physical resources. For example, a set of computational tasks may fit within a programmable hardware device such as a field programmable gate array (FPGA). Control and communication logic may be added to each set, and a hardware definition language (HDL) file is generated for each set. A configuration specification may also be generated detailing how computational tasks are split across multiple HDL files, execution sequence of HDL files, etc. From each HDL file, a configuration binary may be generated. A programmable hardware device then executes the configuration binary.

A user interface insulates a user from the complexity of task management, creation of configuration binaries, distribution of computational tasks across configuration binaries, and so forth. The simple user interface combined with the speed and reconfigurability of programmable hardware makes the actual implementation and execution of the regular expression searching invisible to the user. Instead of laborious manual configuration of programmable hardware, an automated system generates the configuration binaries for the user, executes them, and manages the consolidation of results.

Support for fault tolerance to improve reliability includes redistribution, sparing, and so forth. Performance improvements are available through fragmentation mitigation and prioritization.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 is block diagram illustrating selected components of an architecture suitable for maintaining a regular expression processing system.

FIG. 2 is a block diagram illustrating selected components of the compilation module from FIG. 1 and configuration information which may be generated by the compilation module.

FIG. 3 is a block diagram illustrating selected components of configuration binaries produced by the architecture of FIG. 1.

FIG. 4 is a block diagram illustrating selected components of a configuration specification produced by the architecture of FIG. 1.

FIG. 5 is a block diagram illustrating selected components of a programmable hardware system controller (PHSC) from the architecture of FIG. 1.

FIG. 6 is a flow diagram illustrating execution of configuration binaries by the PHSC.

FIG. 7 is a flow diagram illustrating execution of configuration binaries by the PHSC including storage of state information from the configuration binary.

FIG. 8 is a flow diagram illustrating user interaction with the regular expression processing system.

FIG. 9 is a flow diagram illustrating generation of configuration information based on regular expressions.

FIG. 10 is a flow diagram illustrating estimation of physical resource requirements of a set of regular expressions.

FIG. 11 is a flow diagram illustrating execution of generated configurations on programmable hardware.

FIG. 12 is a flow diagram illustrating dynamic modification of regular expressions.

FIGS. 13-15 are flow diagrams illustrating support for fault tolerance by redistributing configuration binaries to a remaining functional programmable hardware device.

FIGS. 16-18 are flow diagrams illustrating support for fault tolerance through the use of a spare functional programmable hardware device.

FIG. 19 is a schematic illustrating fragmentation mitigation of regular expressions across configuration binaries.

FIG. 20 is a schematic illustrating fragmentation mitigation by selective recompilation of a portion of the regular expressions and corresponding configuration binaries, such as when compilation resources are limited.

FIG. 21 is a schematic illustrating priority-aware hardware assignment of regular expressions, as well as the packing and scheduling of those regular expressions into configuration binaries.

FIG. 22 is a flow diagram illustrating reclamation of idle programmable hardware resources by redistributing the execution of configuration binaries.

FIGS. 23-24 are flow diagrams illustrating prioritization of configuration binaries and the regular expressions within.

FIG. 25 is a flow diagram illustrating merging of regular expressions by multiple users/applications at compilation and execution.

FIG. 26 is a flow diagram illustrating delayed configuration paging of configuration binaries.

FIG. 27 is a flow diagram illustrating compilation of configuration binary subelements, which may then be combined to create a complete configuration binary.

FIG. 28 is a schematic illustrating computation combining of regular expressions.

FIG. 29 is a schematic illustrating supersetting of regular expressions which have duplicative or similar portions.

### DETAILED DESCRIPTION

A regular expression (“reg ex” or “RE”) provides a concise and flexible means for identifying strings of interest, such as particular characters, words, or patterns of characters. For example, a regular expression of “*car*” when parsing a text file may identify the words “car,” “cartoon,” “vicar,” etc.

Regular expressions are widely used in many different fields, ranging from unsolicited commercial email (“spam”) filtering to genetic research. For example, an email server may search for all occurrences of “mortgage” or “credit card” or “enhancement” to determine whether a given email is spam or not. In another example, a doctor may search a patient's DNA to find the sequence “GGCCCAGCATAGATTACA” which indicates a predisposition to cancer. Thus, reg exs are a useful tool in many applications. Unfortunately, as described above, previous methods of implementing reg exs suffered the serious drawbacks of slow speed in software or limited adaptability to changing reg exs processed in hardware.

In this disclosure, regular expressions are automatically converted into corresponding logic and state equations for execution on programmable hardware devices. As part of this process of automatic conversion, the extent of programmable hardware necessary to execute each regular expression may be estimated without burdensome trial and error. In some implementations, trial and error under automated control may be used, such as using feedback derived from compilation reports and modifying a configuration using actual resource utilization. Once estimated, the regular expressions may be distributed into sets, where each set fits within the physical resource constraints of an individual programmable hardware device. For example, a set of 500 regular expressions may fit within a particular FPGA.

Communication and control (CC) logic may be added to each set, which allows for the programmable hardware to be able to communicate with a controller and manage the execution on the programmable hardware. Programmable hardware may communicate with the controller via a data network such as Ethernet, an input/output bus interface such as peripheral component interconnect (PCI), or a central processing unit bus-based interface such as HyperTransport™ as described by the HyperTransport Consortium. A compiler generates a hardware definition language (HDL) file for each set, including the regular expressions and the CC logic. The compiler may also generate a configuration specification detailing the distribution of regular expressions across multiple HDL files, execution sequence, etc. A CAD tool may generate a configuration binary from each HDL file. A programmable hardware device may then execute the configuration binaries.

During execution, the regular expressions within each programmable hardware device execute in parallel, resulting in significant speed increases. For example, the set of 500 regular expressions mentioned above which fit within a particular FPGA are executed in parallel within the FPGA.

Different sets (in the form of configuration binaries) may be loaded and executed on the programmable hardware device in series. This allows regular expression searches to take place which would ordinarily exceed the capacity of the programmable hardware which is available. For example, the first set described above has the 500 regular expressions, while a second set has 300. Together, these 800 regular expressions would be too large for a single programmable hardware device. However, when split into two configuration binaries and executed in series, a single programmable hardware device may execute the entire 800 regular expressions.

A user interface insulates a user from seeing the complexity of task management, creation of configuration binaries, distribution across configuration binaries, and so forth. This simple user interface allows the harnessing of the speed and reconfigurability of programmable hardware to create substantial increases in the execution of computational tasks such as comparing regular expressions against a corpus of data.

The use of programmable hardware to execute reg exs offers two benefits. First, because of the parallel operation provided by the programmable hardware, the capacity of the system is a function of the capacity of the programmable hardware device itself. Thus, it is possible for a programmable hardware-based solution to have constant throughput until it becomes necessary to add another configuration binary to an execution sequence. For example, a set with 300 expressions which can fit within the FPGA will execute in the same time as the 500 expressions above, which fit in that same FPGA. This is in contrast to software solutions in which the performance degrades linearly (or worse) with respect to the number of desired searches, such that 500 expressions take more time to evaluate than 300.

A second advantage that programmable hardware-based regular expression searches offer is that the circuits configured on the programmable hardware provide deterministic performance. As mentioned above, a set of regular expressions configured to fit within a programmable hardware device will execute in a known time. In contrast, throughput of software running on a processor can be dependent upon the nature of the searches desired (more or less complex searches) and the nature of the input data (input streams that have high hit ratios versus those with low hit ratios). Additionally, other unpredictable events such as cache misses may vary the performance.

Redistribution, sparing, and so forth allow for fault tolerance. Performance is maintained by mitigating fragmentation of regular expressions from cancelation or changes through selective or complete recompilation. Regular expressions may also be assigned varying priority levels through packing, scheduling, and execution sequencing.

### Illustrative Architecture

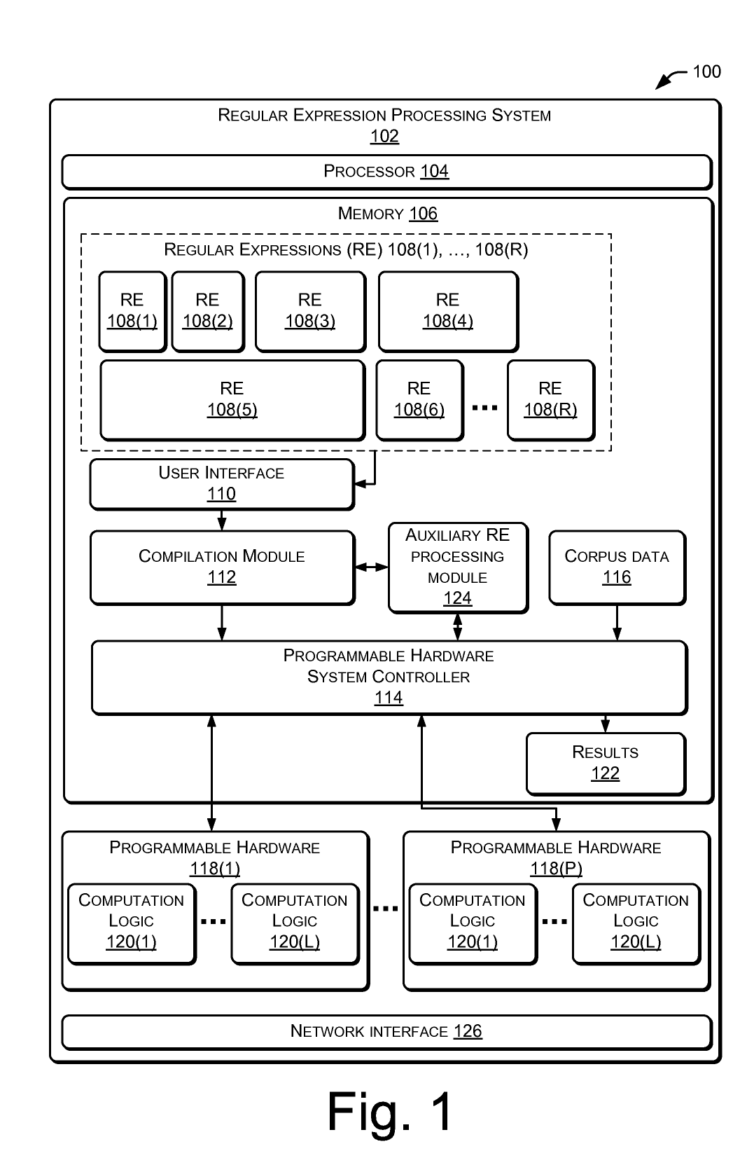

FIG. 1 is block diagram 100 illustrating selected components of an architecture suitable for implementing a regular expression processing system 102. For the purposes of discussion, and not by way of limitation, suppose a company wishes to filter unsolicited commercial email, commonly known as “spam,” from their email server. A set of regular expressions are maintained which incorporate character strings which have been associated with spam. For example, the phrases “mortgage rate” and “credit card” have been determined to indicate spam email. A system administrator or spam utility application generates regular expressions for these phrases.

A collection of emails on company servers forms a corpus of data filtered using this list of regular expressions (reg exs) for removal of potential spam. In practice, such a list of reg exs may extend into the thousands and even millions. Given the computational requirements required by current software-only regular expression searches, this results in a significant server load, with corresponding increases in resource requirements such as servers allocated for the task, power, cooling, etc.

Within regular expression processing system 102 may be a processor 104 configured to execute modules stored in memory 106. In some implementations, processor 104 may be a multiple core processor, or a collection of several processors. Also within regular expression processing system is a memory 106. Memory 106 may store regular expressions 108(1), 108(2), . . . , 108(R). As used in FIGS. 1-29 of this application, letters within parentheses, such as “(R)” or “(P)”, denote any integer number greater than zero. These regular expressions may be of varying size and/or complexity, as indicated by the varying sizes of the blocks representing them.

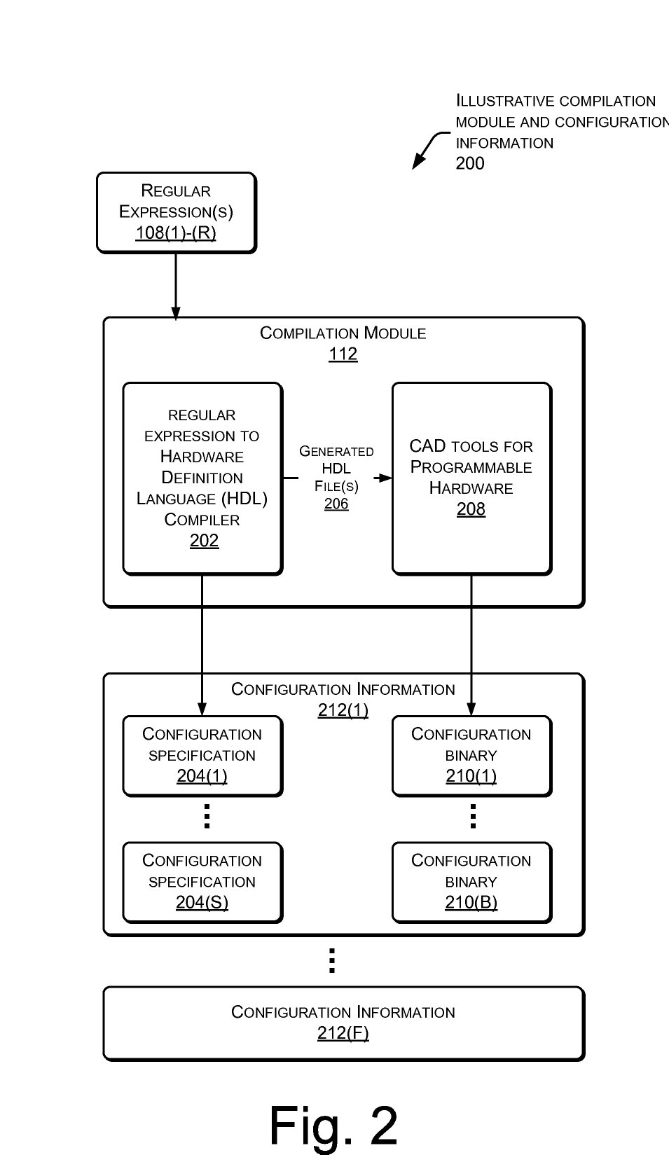

Also within memory 106 is a user interface 110 configured to accept regular expressions and convey them for processing by compilation module 112 which is also in memory 106. Compilation module 112 is configured to generate configuration information suitable for loading and execution onto programmable hardware, and is described in more detail with regards to FIG. 2 below.

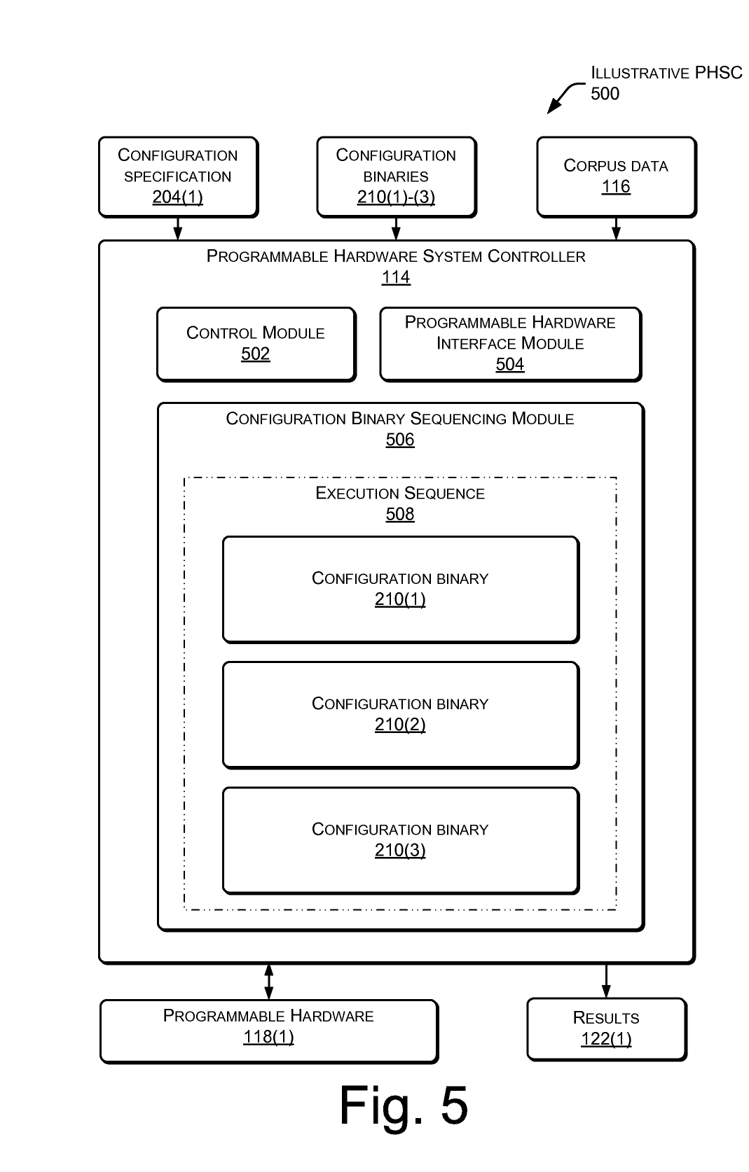

Compilation module 112 is in communication with programmable hardware system controller (PHSC) 114 may be stored in memory 106. PHSC 114 is configured to manage operation of programmable hardware, and is described in more detail with regards to FIG. 5 below. PHSC 114 may be executed as a software module (as depicted), as a hardware device, or as a combination.

PHSC 114 is also configured to accept corpus data 116 within memory 106 or other external data for processing. In some implementations, this corpus data may include information against which the regular expressions are to be executed. For example, a collection of email messages to be searched for spam phrases expressed as regular expressions.

PHSC 114 is in communication with programmable hardware 118(1), 118(2), . . . , 118(P). Programmable hardware 118 may be field programmable gate arrays (FPGA), complex programmable logic devices (CPLD), or other reconfigurable hardware devices. Programmable hardware 118 may be similar (such as the same model FPGA from the same manufacturer) or different (such as FPGAs from different manufacturers). Within each programmable hardware 118 may be one or more computational logic blocks 120(1), 120(2), . . . , 120(L) which are the physical manifestation within the programmable hardware device 118 of regular expressions 108(1)-(R) as well as any requisite communication and control (CC) logic.

PHSC 114 loads configurations into programmable hardware 118 which creates computation logic 120. After computation logic 120 runs, CC logic in the programmable hardware 118 may transfer results to the PHSC 114, which may then output results 122 to memory 106 or some other external data destination. Regular expressions 108 which are not included in the configuration for execution on programmable hardware devices 118 may be executed in auxiliary regular expression processing module 124. For example, a newly added spam phrase “roofing repair” may be added to the list of regular expressions, but not compiled into a configuration binary for hardware execution. Until compilation, the regular expression for this newly added spam phrase may be processed using auxiliary regular expression processing module 124. Auxiliary regular expression processing module 124 may be stored in memory 106 and be in communication with compilation module 112 and PHSC 114.

Given the performance advantage of programmable hardware 118 configured to execute regular expressions in parallel, the programmable hardware 118 may outstrip the demands placed on it. As a result, the programmable hardware 118 may be underutilized. By dynamically reconfiguring the programmable hardware 118, it becomes possible to trade that excess performance for virtual capacity. As a result a smaller programmable hardware device may be used. Or, when demand increases to the point where a single piece of programmable hardware can no longer contain all of the reg exs 108(1)-(R), the reg exs may be split to create multiple computation logics 120(1)-(L) which may be loaded and run serially. While serial execution of computation logic is somewhat slower, it far surpasses the complete failure which may occur when loading computation logic which exceeds the capacity of programmable hardware 118.

Regular expression processing system 102 may also incorporate a network interface 126 which may be configured to communicate with other devices such as servers, workstations, network attached FPGA devices, and so forth.

FIG. 2 is a block diagram 200 illustrating selected components of compilation module 112 from FIG. 1. Regular expressions 108(1)-(R) are provided to compilation module 112, such as via user interface 110. Compilation module 112 is configured to compile the regular expressions into a form executable by the programmable hardware 118. A regular expression to hardware definition language (HDL) compiler 202 generates a HDL representation of the regular expressions 108.

A hardware definition language (also known as a hardware description language) represents a description of digital logic and electronic circuits configured to perform a computation. Where computer code represents an algorithm, a HDL statement represents actual circuit elements.

One HDL is very high speed integrated circuit hardware description language (VHDL), as described by the Institute of Electrical and Electronics Engineers (IEEE) standard IEEE 1076. Another HDL is Verilog as described in IEEE Standard 1364-2001. Other HDLs are available and may also be used.

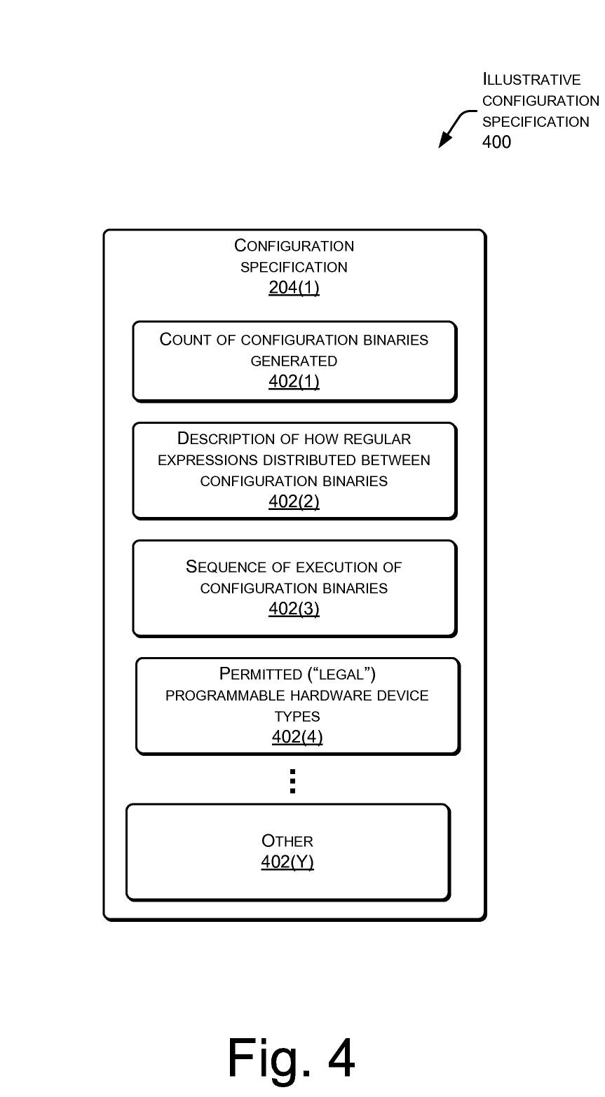

Once regular expression to HDL compiler 202 has compiled the reg exs 108 to produce the HDL file, a configuration specification 204(1), 204(2), . . . , 204(S), may be generated based on information resulting from the compilation. The configuration specification includes details such as how many reg exs 108 are distributed across configuration binaries, and so forth, and is described in more detail below with regards to FIG. 4.

Compiler 202 provides HDL files 206 to a computer-aided design (CAD) tool for programmable hardware 208. This CAD tool 208 accepts HDL files 206 and generates configuration binaries 210(1), 210(2), . . . , 210(B) suitable for execution by the programmable hardware devices 118. For ease of reference, the configuration specification 204 and configuration binary 210 may be considered configuration information 212. In one implementation, a single configuration specification 204 may be generated which relates to multiple configuration binaries 210(1)-(B). In another implementation, multiple configuration specifications 204(1)-(S) may be generated corresponding to multiple configuration binaries 210(1)-(B). In some implementations, there may be configuration information 212(1), 212(2), . . . , 212(F).

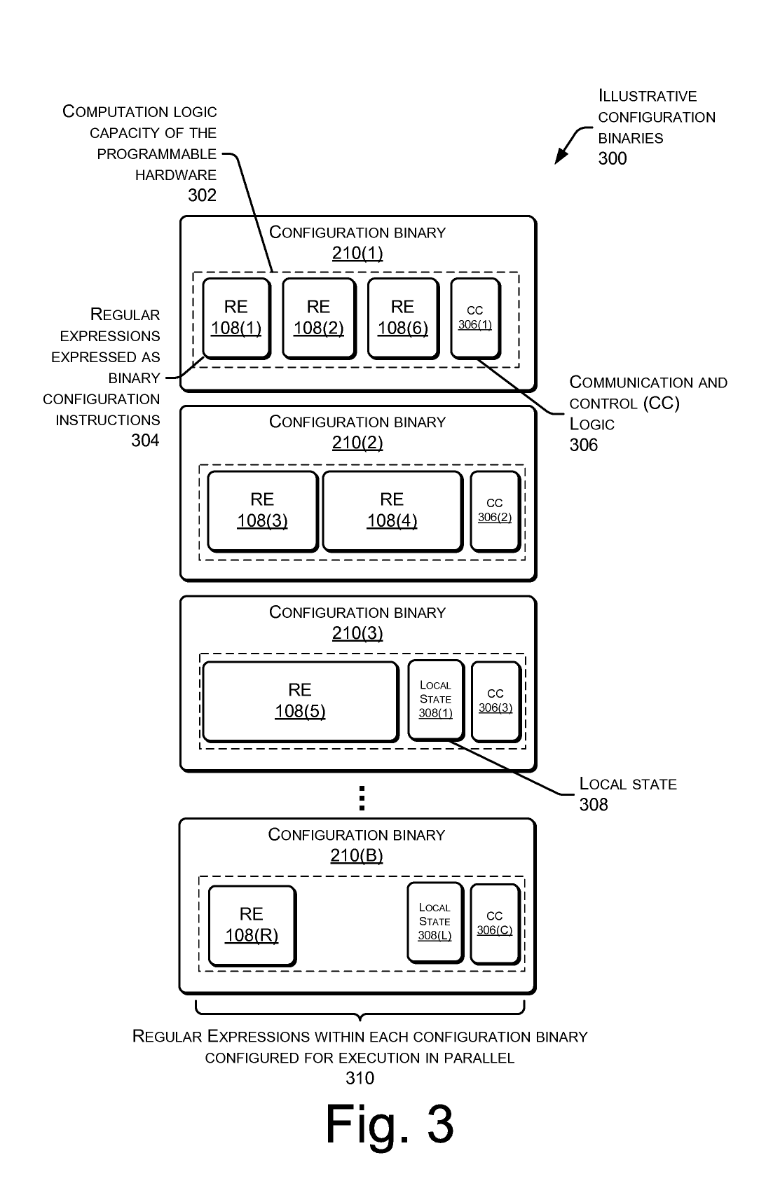

FIG. 3 is a block diagram 300 illustrating selected components of illustrative configuration binaries produced by the architecture of FIG. 1. In this figure, broken line 302 delineates the capacity of the programmable hardware 118. Within configuration binary 210 and within this capacity 302 may be reg exs expressed as binary configuration instructions 304, such as those generated by compilation module 112. Also included within the configuration binary 210 may be communication and control (CC) logic 306 configured to allow coupling between PHSC 114 and programmable hardware device 118. In some implementations, local state storage 308 may also be provided within the configuration binary 210.

In this figure, configuration binary 210(1) includes reg exs 108(1), (2), (6), and CC 306(1). Configuration binary 210(2) includes reg exs 108(3), (4), and CC 306(2). Configuration binary 210(3) includes reg ex 108(5), local state storage 308(1) and CC 306(3). Note that the reg exs depicted vary in width, indicating a variation in the size/complexity of the regular expression within. Thus, reg ex 108(5) is the sole reg ex within configuration binary 210(3) because it requires a majority of the available computational logic capacity.

Each configuration binary 210 may be configured such that the reg exs within are designed for parallel execution 310. For example, upon execution in programmable hardware 118 of configuration binary 210(1), reg exs 108(1), (2), and (6) are executed in parallel. This ability to execute several reg exs in parallel in hardware results in significant speed increase over software which executes in series on a single processor. Returning to our example of FIG. 1, execution of configuration binary 210(1) by programmable hardware 118 performs the search for three reg exs at once, in contrast to the serial processing done in software.

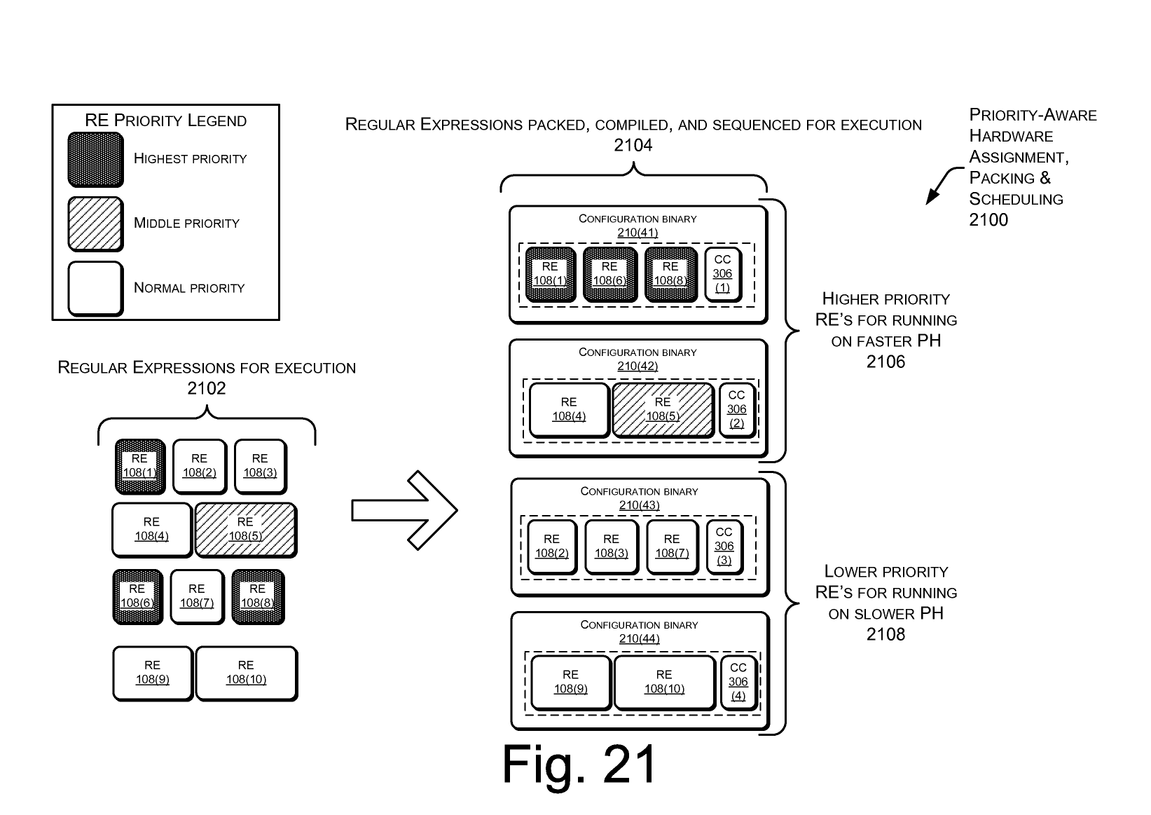

FIG. 4 is a block diagram 400 illustrating selected components of a configuration specification 204 produced by the architecture of FIG. 1. A configuration specification 204 may include several pieces of information. A count of configuration binaries generated 402(1) may be stored. For example, compiled regular expressions produce three configuration binaries. A description of the distribution of regular expressions between configuration binaries 402(2) may also be stored. For example, this may indicate that reg exs 108(1), (2), and (6) are within configuration binary 210(1). A sequence of execution of the configuration binaries 402(3) may be included. For example, execute configuration binary 210(1) first, followed by 210(3), then 210(2) to account for prioritization of a particular regular expression. FIG. 21 below discusses prioritization in more detail. Configuration specification 204(1) may also include what the permitted or “legal” programmable hardware devices 118 are within the regular expression processing system 102. For example, programmable hardware devices currently available within the system include FPGA types A and B from Manufacturer X and FPGA type C from Manufacturer Y. Other information 402(Y) may also be included in configuration specification 204(1), such as compilation date/time, application identification and/or user identification, etc.

FIG. 5 is a block diagram 500 illustrating selected components of a programmable hardware system controller (PHSC) from the architecture of FIG. 1. In this illustration, PHSC 114 accepts configuration specification 204(1) and corresponding configuration binaries 210(1)-(3), along with corpus data 116. For example, the configuration specifications may include expressions corresponding to the regular expressions 108(1)-(R) for spam searching while the corpus may include the email store to be checked for spam.

PHSC 114 may include a control module 502 configured to coordinate the actions of the PHSC 114, including receiving inputs and providing results 122. A programmable hardware interface module 504 configured to communicate with the programmable hardware devices 118 and manage tasks such as loading and unloading of configuration binaries, transfer of results 122, and so forth may also be included in PHSC 114. A configuration binary sequencing module 506 may also be present. Configuration binary sequencing module 506 may determine an execution sequence 508 (indicated in this illustration with a broken line) for processing of configuration binaries 210 within the programmable hardware 118. For example, execution sequence 508 may be configuration binary 210(1), configuration binary 210(2), followed by configuration binary 210(3). Execution sequence 508 may be based on the sequence of execution of configuration binaries 402(3) from the configuration specification 204. In some implementations, execution sequence 508 may vary from the sequence of execution 402(3) due to changes in priority, unavailability of hardware, processing loads, and other factors available to PHSC 114.

### Illustrative Execution

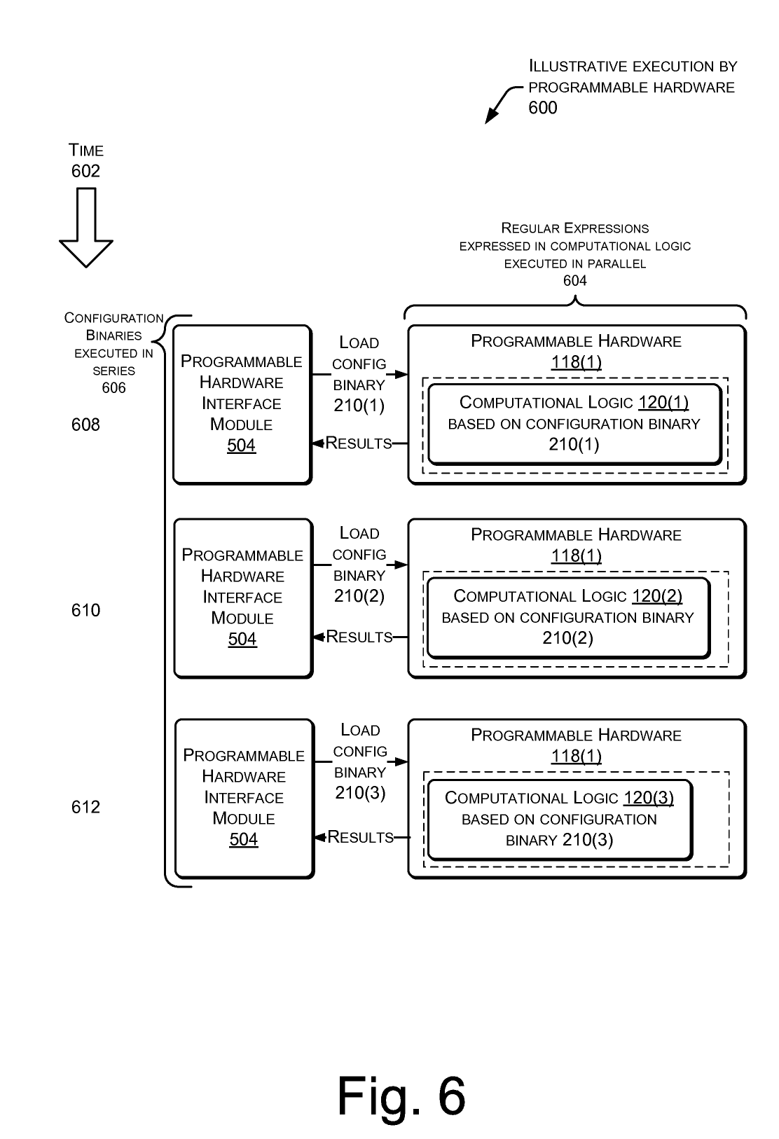

FIG. 6 is a flow diagram 600 illustrating execution of configuration binaries by the PHSC 114 on programmable hardware 118. For this example, assume that there is a single programmable hardware device 118(1), and that time increases down the page, as indicated by arrow 602. Reg exs 108(1)-(R) are compiled to form configuration binaries 210(1)-(B) which upon loading into, and configuration of, the programmable hardware device 118 become computational logic 120. Once loaded into programmable hardware 118(1), the computational logic 120 runs in parallel the regular expression searches encoded within 604. A sequence of configuration binaries may be loaded and processed in series 606, one configuration binary after another.

For example, at 608, programmable hardware interface module (PHIM) 504 in PHSC 114 loads configuration binary 210(1) into programmable hardware 118(1). Once loaded, the resulting physical arrangement of circuitry within the programmable hardware 118(1) is computational logic 120(1). The computational logic 120(1) runs and the results are passed back to PHIM 504.

At 610, PHIM 504 loads configuration binary 210(2), which was next in the execution sequence 508 of PHSC 114, into programmable hardware 118(1) forming computational logic 120(2). Computational logic 120(2) runs, and returns results to PHIM 504.

At 612, PHIM 504 loads configuration binary 210(3), which was next in the execution sequence 508 of PHSC 114, into programmable hardware 118(1) forming computational logic 120(3). Computational logic 120(3) runs, and returns results to PHIM 504.

This consecutive loading of configuration binaries and running the resulting computational logic allows a virtualization of the programmable hardware, creating a virtualized computational fabric. For example, instead of requiring an individual piece of programmable hardware 118 large enough to run all regular expressions to be processed, the reg exs may be split out to execute across one or more programmable hardware devices 118. When the available programmable hardware devices are insufficient to allow simultaneous operation (for example, when demands of reg exs exceed available capacity of the programmable hardware devices), reg exs may be distributed across multiple configuration binaries, which may in turn be distributed across a limited number of programmable hardware 118, and/or executed on the same programmable hardware 118 in series. Returning to our earlier example of 800 regular expressions for spam searching, all 800 may not fit on a single FPGA, but 500 will. Thus, a first configuration binary is created with 500 regular expressions while a second configuration binary is created with the remaining 300 regular expressions. With one programmable hardware 118 device available, the first configuration binary is loaded and run, then the second configuration binary is loaded and run.

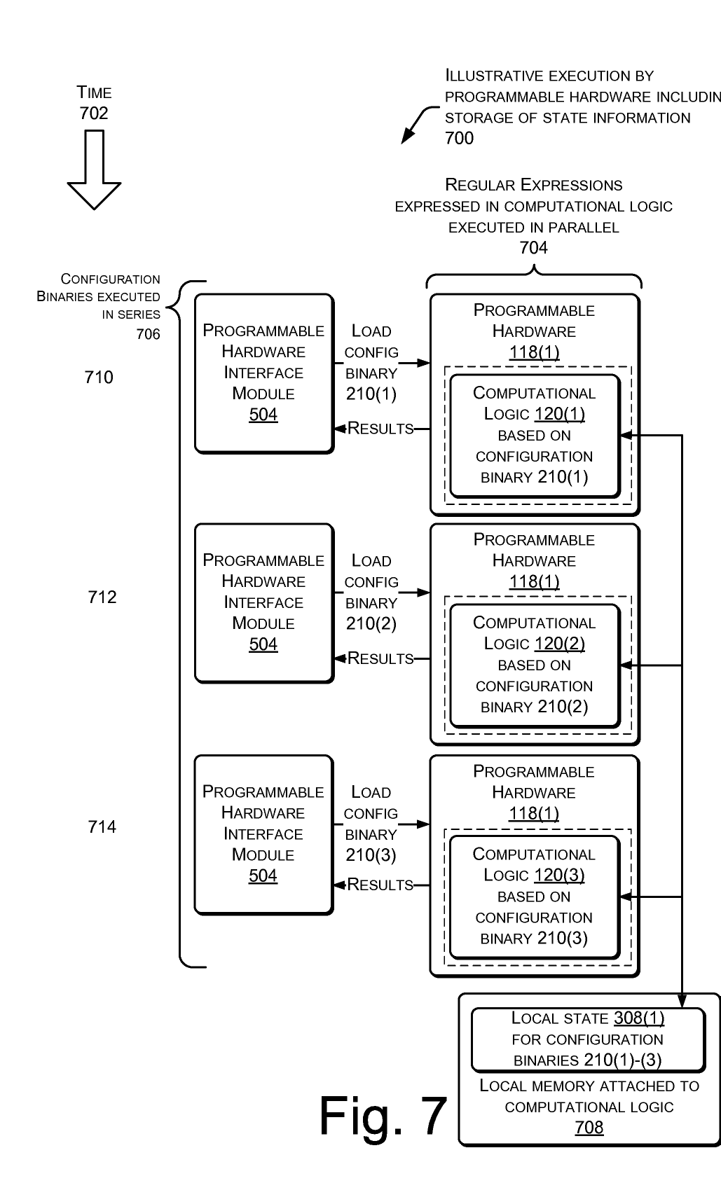

To improve performance and/or to allow a series of configuration binaries to iteratively execute based on the results of the previous step (i.e., be pipelined), state information may be stored. FIG. 7 is a flow diagram 700 illustrating execution of configuration binaries by the PHSC 114 with storage of state information from the configuration binary. As described above with respect to FIG. 6 above, time increases down the page as indicated by arrow 702. Also as above, in this example, regular expressions expressed in computational logic resulting from a configuration binary are run in parallel 704, while multiple configuration binaries are loaded and executed serially 706 on a single piece of programmable hardware 118(1). At 708, local memory attached to the computational logic, or in another implementation embodied within the computational logic, stores state information. For example, in one implementation of local memory attached to the computational logic, the memory may be external to the programmable hardware device, such as an attached flash memory. Use of memory 708 which is directly accessible to programmable hardware 118(1) increases speed and eliminates the need to transfer and store the state through the PHS C 114.

At 710, PHIM 504 loads configuration binary 210(1), resulting in computational logic 120(1), which runs and may store local state information 308(1) in local memory 708. At 712, PHIM 504 loads configuration binary 210(2), resulting in computational logic 120(2), which may access local state information 308(1) and read and/or write information to memory 708. At 714, PHIM 504 loads configuration binary 210(3), resulting in computational logic 120(3), which may also access local state information 308(1) and read and/or write information to memory 708. Thus, information may persist between the executions of the configuration binaries.

For example, suppose reg ex 108(1) in configuration binary 210(1) is a reg ex for the string “car,” while reg ex 108(3) in configuration binary 210(2) is a reg ex for the string “car loan” and reg ex 108(5) in configuration binary 210(3) is a reg ex for the string “car loan refinancing.” During execution of these configuration binaries, the state information 308(1) may be saved in memory 708, such that configuration binary 210(3) uses the results from configuration binary 210(2) which in turn uses results from 210(1). Thus, by accessing state information stored in memory accessible directly by the programmable hardware 118, processing speed is increased. Furthermore, storage may facilitate splitting a reg ex which is so large it exceeds the capacity of a single programmable hardware device.

### Illustration of Processes

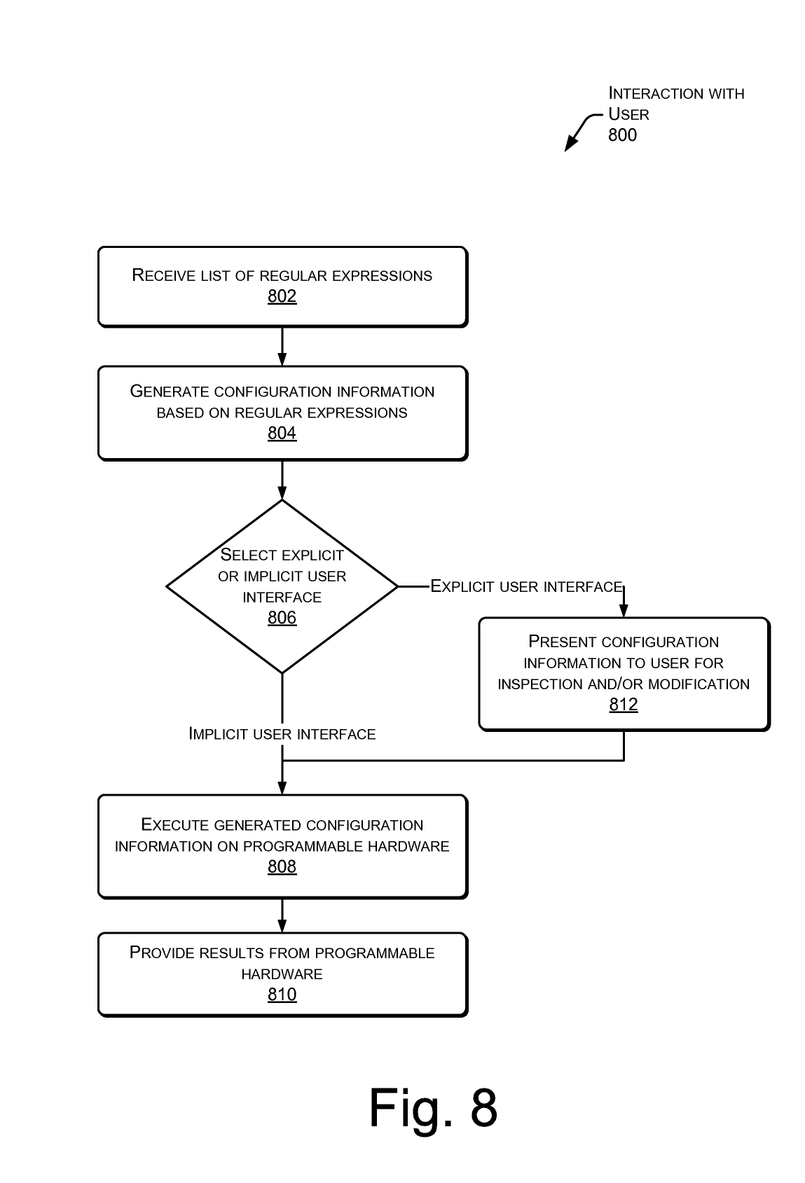

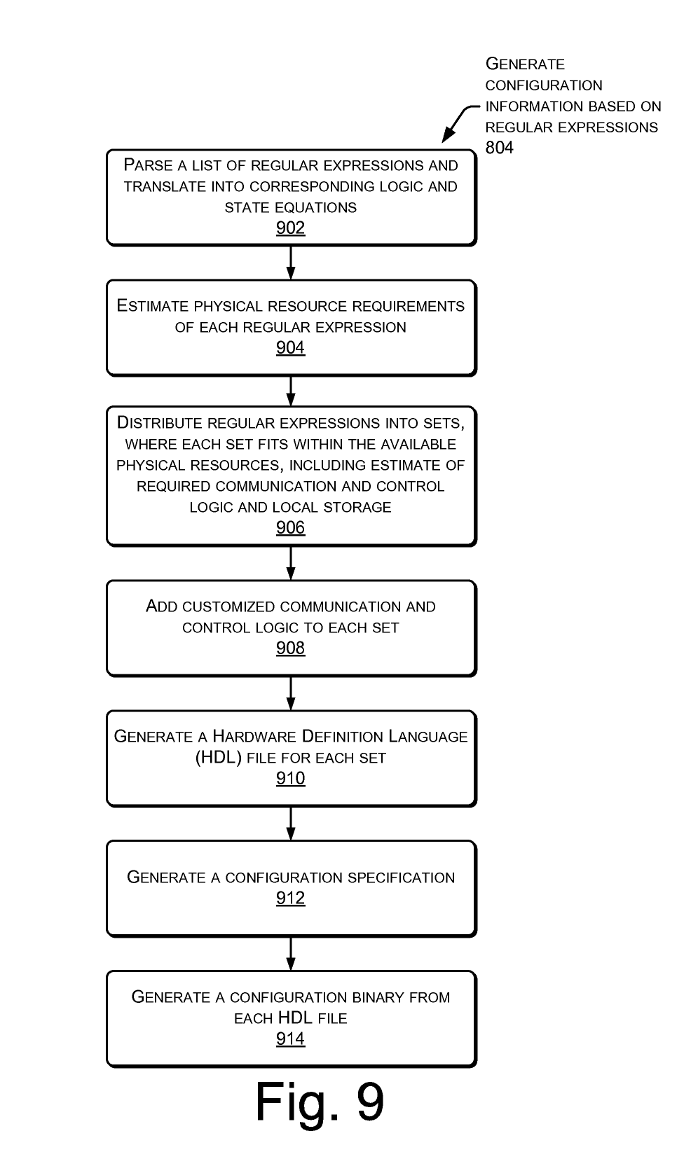

FIG. 8 shows a flow diagram 800 illustrating user interaction with the regular expression processing system 102 that may, but need not, be implemented using the architecture shown in FIGS. 1-7. The flow 800 (as well as those in FIGS. 9-12) is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the process will be described in the context of the architecture of FIGS. 1-7.

Block 802 receives a list of regular expressions. For example, a list of spam search criteria expressed as regular expressions. Block 804 generates configuration information based on the regular expressions. This is discussed in more depth below with regards to FIG. 9.

A user may see a different interface depending on whether an explicit or implicit user interface is selected at block 806. Upon selection at block 806 of an implicit user interface, block 808 executes the generated configuration information on the programmable hardware. Block 810 provides the results from the programmable hardware.

Upon selection at 806 of an explicit user interface, block 812 presents the configuration information (including configuration specification 204 and configuration binary 210(1)-(R) to the user for inspection and/or modification. For example, a user who wishes to manually adjust the automatically generated configuration binaries may select an explicit interface. Once this presentation is complete, the flow may resume at block 808 and execute the generate configuration on programmable hardware as described above.

Regardless of interface selected, this user interface provides simple interaction with the programmable hardware regardless of the reg ex complexity. This frees the user from the necessity to know, or even care about, the programmable hardware details. Furthermore, this provides search portability across different pieces of programmable hardware 118. For example, reg exs 108(1)-(R) may be compiled to execute across different programmable hardware 118(1)-(P) and be distributed across them as they become available to process. The use of this interface conceals this complexity from the user.

FIG. 9 shows a flow diagram illustrating generation of configuration information based on regular expressions 804 as mentioned above with respect to FIG. 8. Block 902 parses a list of regular expressions and translates them into corresponding logic and state equations. This translation may occur within compilation module 112, as described above. Block 904 estimates the physical resource requirements of each regular expression. For example, reg ex 108(1) may be estimated to require 2,000 computational elements on programmable hardware 118(1) while reg ex 108(5) may be estimated to require 7,000 computational elements.

Block 906 distributes regular expressions into sets, where each set fits within the available physical resources in programmable hardware 118. This estimation may also include communication and control (CC) logic as well as local storage requirements. For example, in FIG. 3 above, the available physical resources are the computational logic capacity 302 of the programmable hardware, and one of the sets includes reg ex 108(1), 108(2), 108(6), and CC 306(1).

Block 908 adds the customized communication and control logic to each set, while block 910 generates a HDL file for each set. Block 912 generates a configuration specification, such as configuration specification 204(1). Block 914 generates a configuration binary from each HDL file. For example, an HDL file may result in configuration binary 210(1).

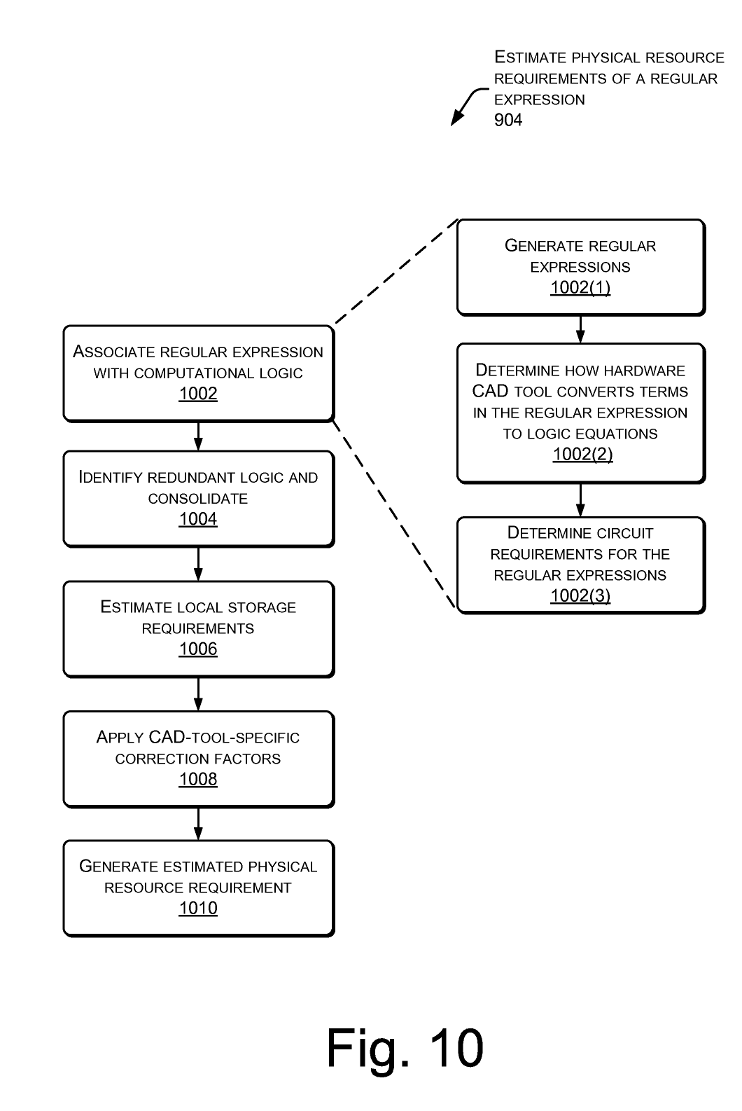

FIG. 10 shows a flow diagram illustrating estimation of physical resource requirements by a regular expression 904, as mentioned above with respect to FIG. 9. Block 1002 associates a regular expression with a particular computational logic arrangement. For example, a regular expression for the string “home” may involve a particular arrangement of 200 circuit elements. This association may be made by block 1002(1) generating a regular expression, block 1002(2) determining how a hardware CAD tool converts terms in the reg ex to logic equations, and block 1002(3) determining circuit requirements for the reg ex. For example, a sample regular expression may be converted into logic equations by the CAD tool, with resulting requirements being monitored. Thus, a model may be built allowing prediction of the circuit requirements based on regular expression inputs.

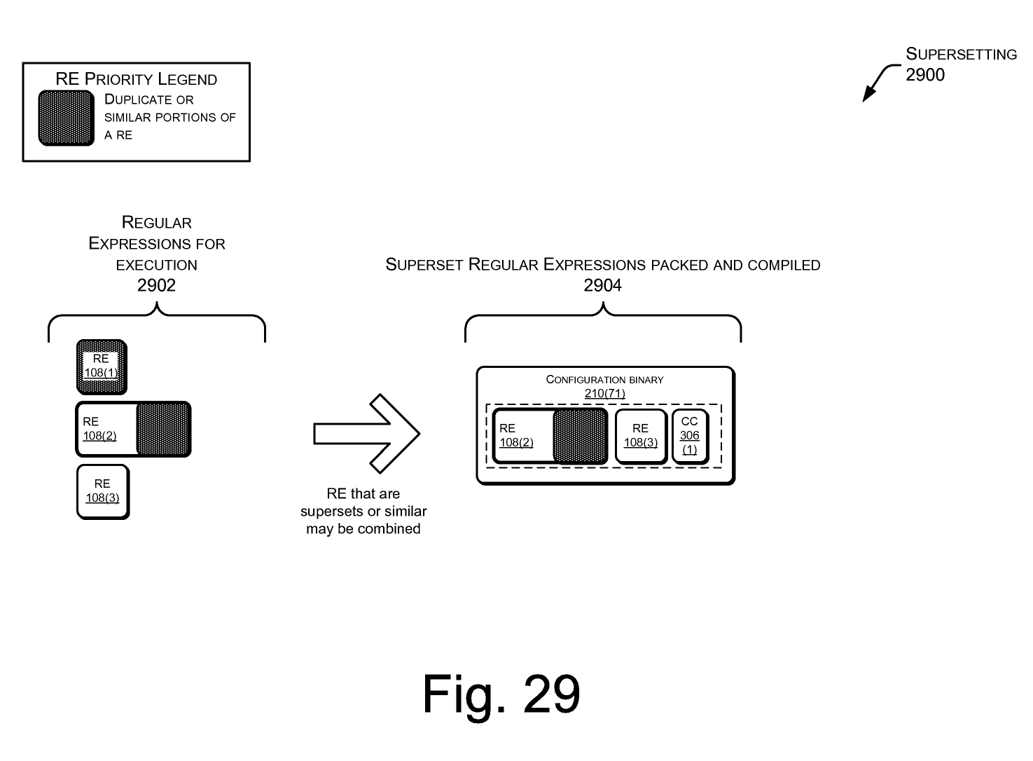

Once the association is made, block 1004 identifies redundant logic and consolidates to remove these redundancies and form consolidated logic. For example, several regular expressions may involve a common root string or have other commonalities, which when expressed in circuitry may be result in redundant circuits. These redundancies may be removed, improving efficiency. One implementation of this is discussed below with regards to FIG. 29 in the context of supersetting.

Block 1006 estimates local storage requirements, such whether local state storage 308 will be called for, and if so, what memory resources are required. Block 1008 applies CAD-tool specific correction factors to the consolidated logic and local storage requirements. For example, a particular CAD-tool may translate the logic equations called for by a particular reg ex into computational blocks in an unusual manner, thus a correction factor may be input to allow the estimation of the physical resource to be more accurate.

Block 1010 generates an estimated physical resource requirement. For example, a reg ex to search for “credit card” may require an estimated one thousand circuit elements on the FPGA type A from Manufacturer X. This estimate is substantially faster, less resource intensive, and requires less or no human interaction compared to brute-force trial and error used to determine whether reg exs will fit within the physical resources of programmable hardware 118. Furthermore, this process may be easily applied to multiple types of programmable hardware 118 with varying capacities, allowing for rapid redeployment of reg exs to new hardware.

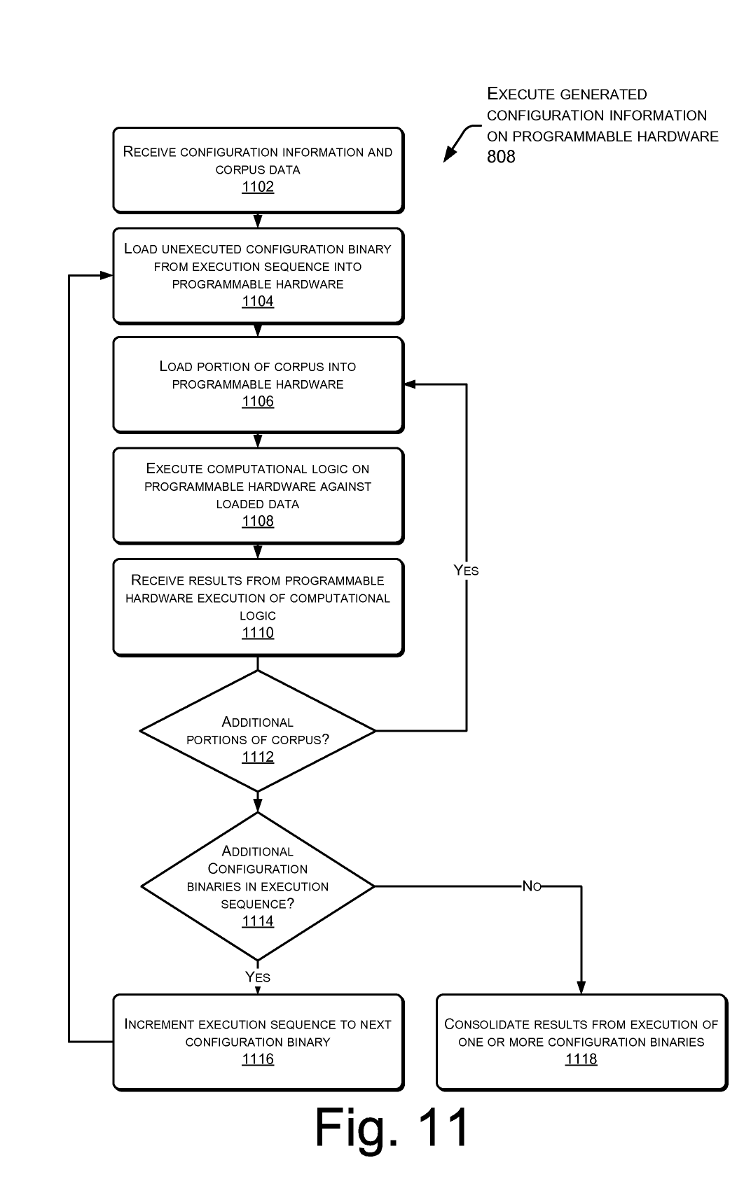

FIG. 11 is a flow diagram illustrating execution of generated configuration information on programmable hardware 808 as mentioned above with respect to FIG. 8. In one implementation, the following blocks may be performed by PHSC 114.

Block 1102 receives configuration information 212 and corpus data 116. For example, configuration files may include configuration binaries 210 which embody regular expressions 108 for a spam search while corpus data 116 may be the raw email to be searched for spam.

Block 1104 loads unexecuted configuration binaries from the execution sequence 508 into programmable hardware 118. Block 1106 loads all or a portion of the corpus 116 into the programmable hardware 118 for processing. Block 1108 executes the computational logic 120 on the programmable hardware 118 against the loaded corpus data 116. Block 1110 receives results from the programmable hardware's execution of the computational logic. When additional portions of the corpus remain, block 1112 returns the flow to block 1106 and loads another portion of the corpus into the programmable hardware 118 for processing. Otherwise, when no additional portions of the corpus remain at block 1112, block 1114 determines whether additional configuration binaries are present in the execution sequence 508. When additional configuration binaries remain in the execution sequence 508, block 1116 increments the execution sequence to the next configuration binary and returns the flow to 1104. When no additional configuration binaries remain in the execution sequence 508, block 1118 consolidates results from execution of the one or more configuration binaries.

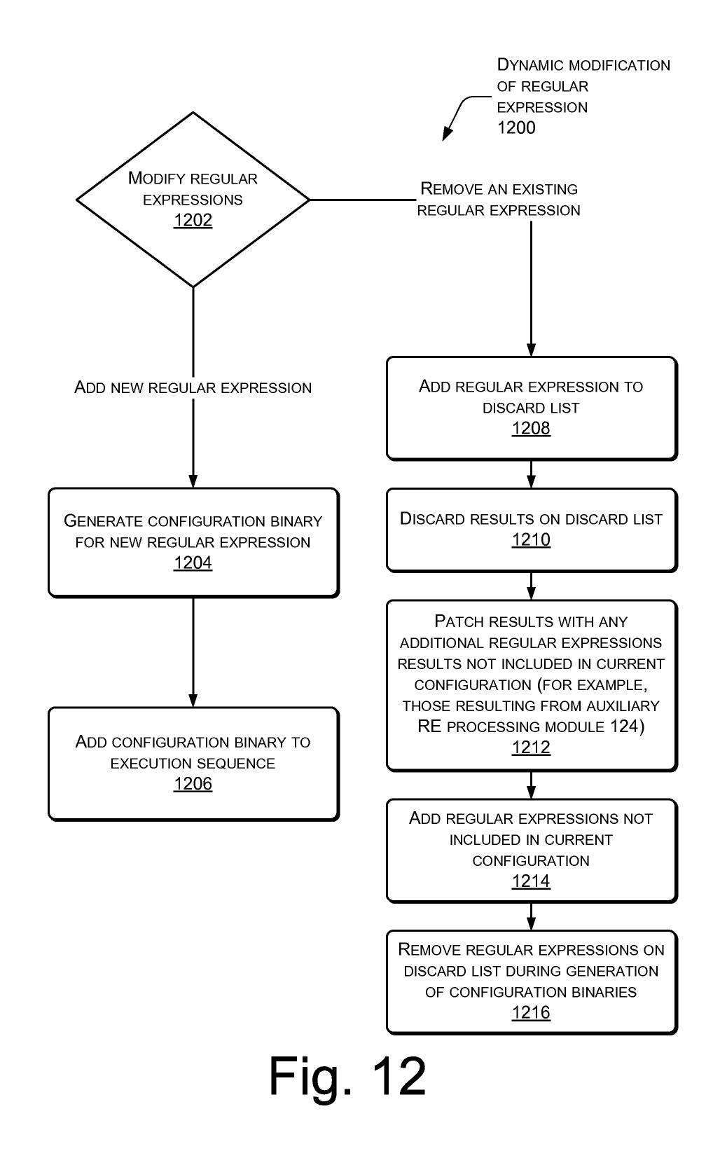

FIG. 12 is a flow diagram 1200 illustrating dynamic modification of regular expressions. Reg exs may change over time. For example, a new fad in the sale of parakeets may result in “parakeet” being added to the spam search list. Or the addition of a new line of credit card business may result in removal of “credit card” from the spam search list.

For ease of discussion, and not by way of limitation, modifications to a list of regular expressions may be generally considered to fall into two categories: the addition of a new regular expression or the removal of an existing regular expression. When block 1202 determines that a new regular expression is to be added, block 1204 generates a configuration binary for the new regular expression. Block 1206 then adds this configuration binary to the execution sequence 508.

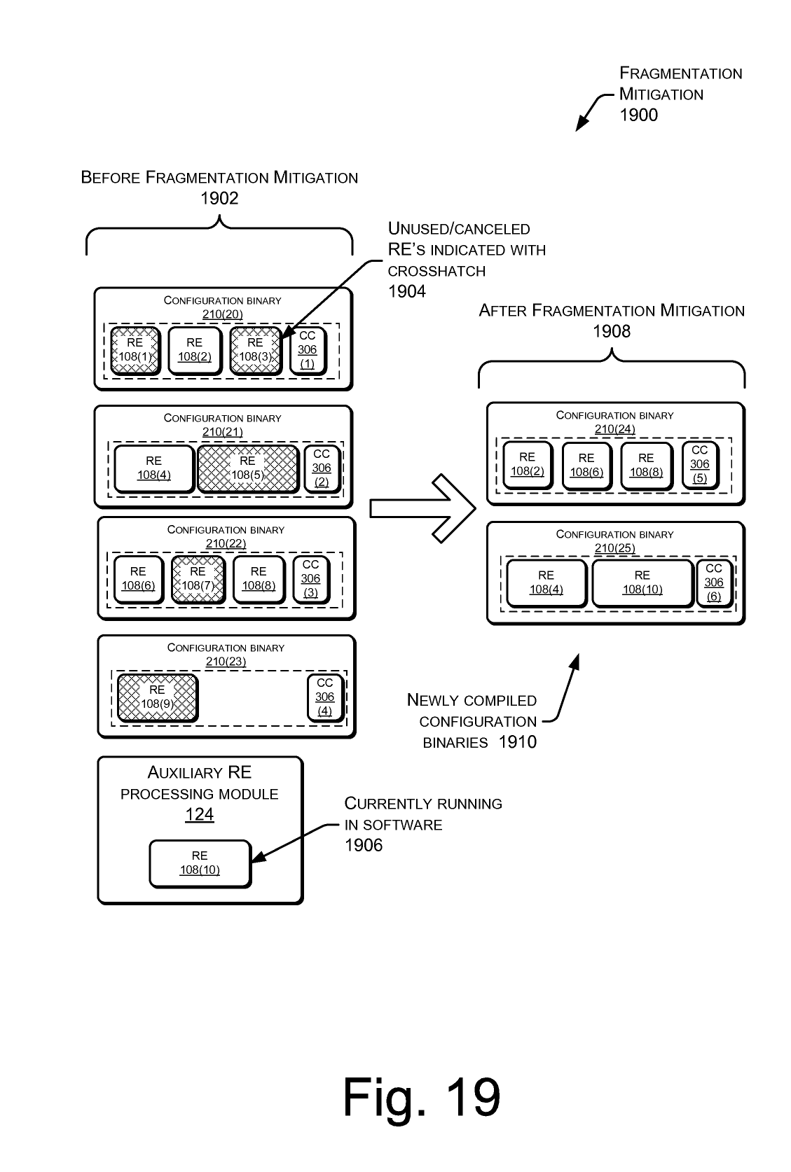

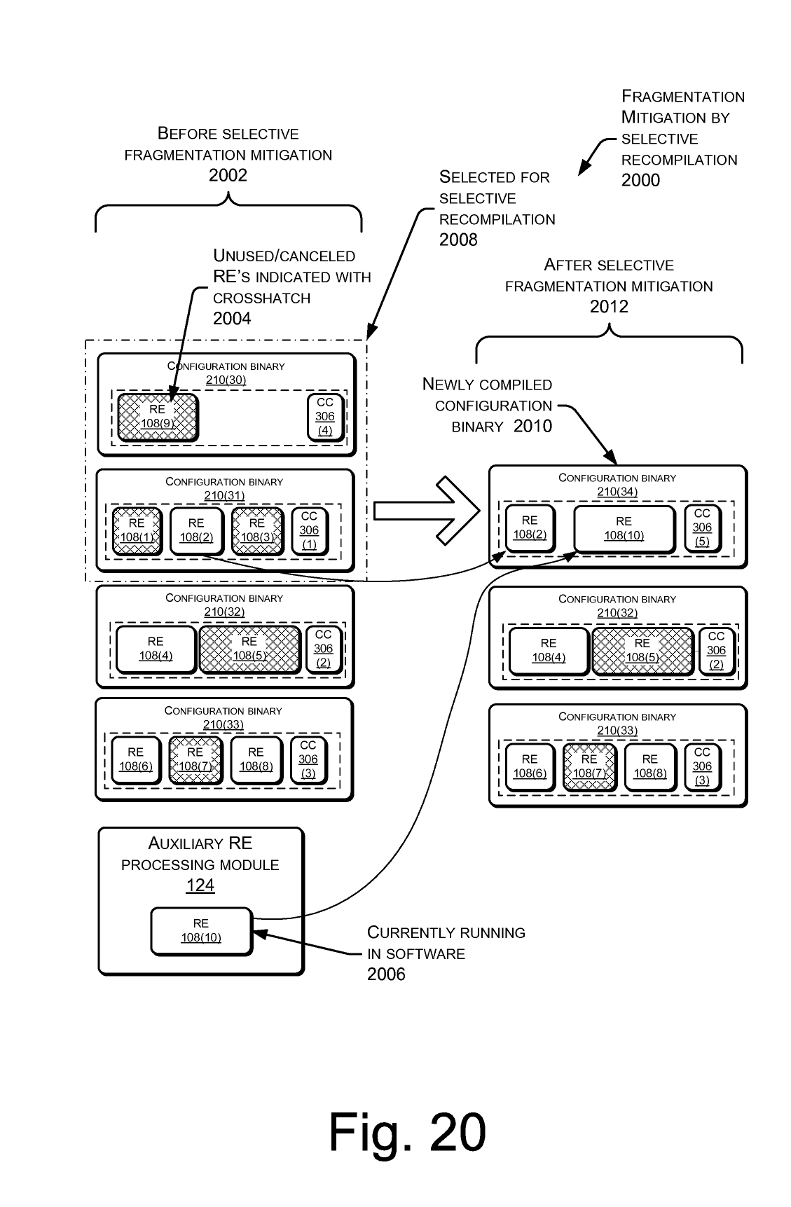

When block 1202 determines the modification is for removal of an existing regular expression, block 1208 adds the regular expression to a discard list. After execution of the computational logic 120 on programmable hardware 118, block 1210 discards results from reg exs. In some implementations, this discard may be via active deletion, while in others the results from the discarded reg ex may be unreported by PHSC 114. While continuing to process a reg ex on a discard list may appear wasteful, it is actually quite efficient given the parallel processing of the reg exs within each configuration binary. As discussed above with regard to FIG. 6, the reg exs within a configuration binary are executed in parallel. Thus, until a configuration binary becomes heavily fragmented, it is cheaper to execute in parallel the many reg exs and discard one of those results than to recompile an entire configuration binary. Furthermore, a user may easily re-instate a previously discarded reg ex by simply removing it from the discard list and re-enabling it, in which case re-compilation may be avoided. The determination of how and when to recompile to address fragmentation resulting from unused/cancelled reg exs is discussed in more depth below with regards to FIGS. 19-20.

Block 1212 patches results from the programmable hardware 118 with the additional regular expression results not included in the current configuration. This may be useful when some reg exs are executed in auxiliary regular expression processing module 124, such as those which have been recently added to the system but have not yet been compiled into configuration binaries 210 for execution on programmable hardware 118.

Block 1214 may add regular expressions not included in the current configuration, such as those executing in auxiliary regular expression processing module 124, into the current configuration. These may be compiled by compilation module 112 for incorporation into configuration binaries 210 which are part of the execution sequence 508. Block 1216 removes regular expressions present on the discard list during generation of the new configuration binaries, thus clearing away the discards.

### Fault Tolerance Through Redistribution

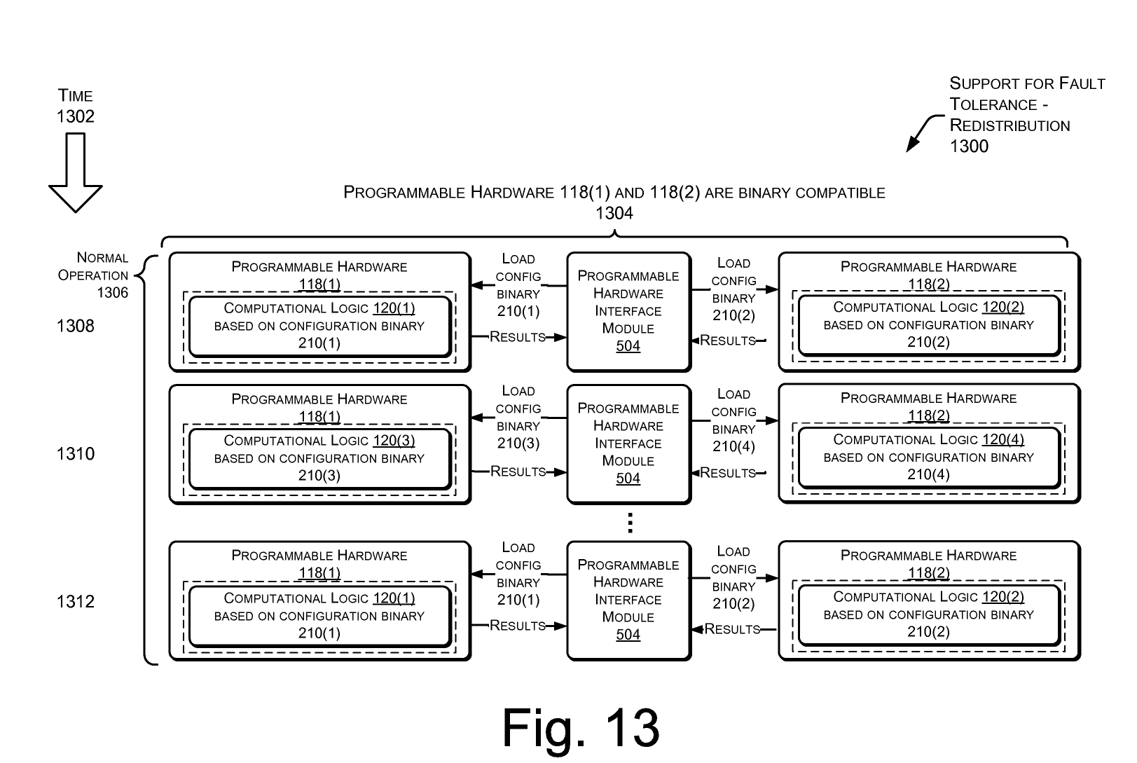

Equipment, including programmable hardware devices 118, may fail. FIGS. 13-15 are a flow diagram 1300 illustrating support for fault tolerance by redistributing configuration binaries to a remaining functional programmable hardware device. In these diagrams, time increases down the page, as indicated by arrow 1302. Beginning with FIG. 13, the PHIM 504 is shown coupled to two programmable hardware devices, 118(1) and 118(2). For this example, assume programmable hardware 118(1) and 118(2) are binary compatible 1304, that is, the same configuration binary 210 may be executed on either without recompilation. Also assume that execution sequence 508 is for configuration binary 210(1), (2), (3), (4), (1), (2), (3), (4), and so on. FIG. 13 shows normal operation 1306. During normal operation 1306, at 1308 PHIM 504 loads configuration binaries 210(1) and (2) into programmable hardware 118(1) and 118(2), respectively. The resulting computational logic 120(1) and 120(2) runs, and results are returned to PHIM 504. Likewise, at 1310 configuration binaries 210(3) and 210(4) are loaded and executed. At 1312, the sequence repeats, loading configuration binaries 210(1) and (2) for processing. This demonstrates the versatility of virtualizing the programmable hardware: Four configuration binaries, 210(1)-(4) are executed on only two pieces of programmable hardware 118(1)-(2).

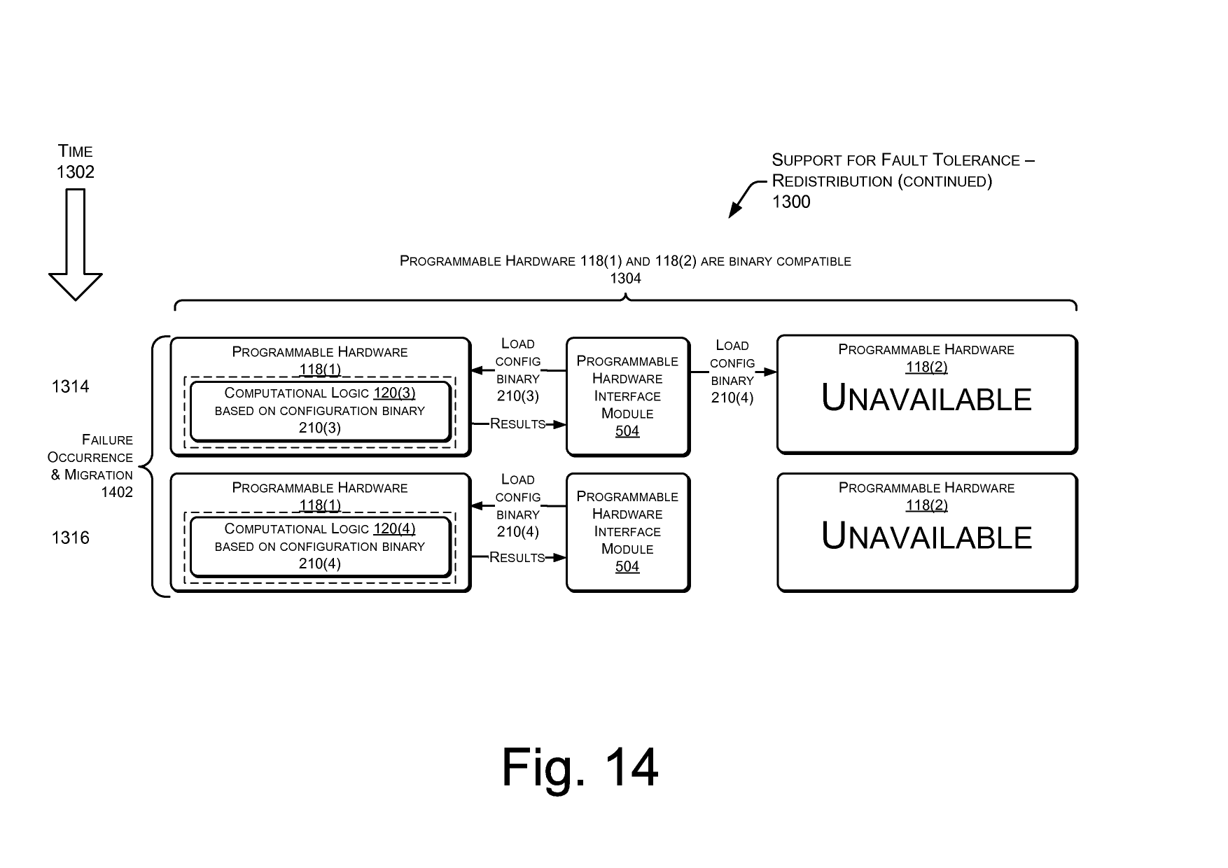

FIG. 14 continues this flow diagram to demonstrate failure occurrence and migration 1402. At 1314, configuration binary 210(3) has successfully loaded to programmable hardware 118(1), while the loading of configuration binary 210(4) to programmable hardware 118(2) was attempted, but failed due to unavailability. After the return of results to PHIM 504 from computational logic 120(3) based on configuration binary 210(3), at 1316 PHIM 504 loads configuration binary 210(4) into programmable hardware 118(1) for processing.

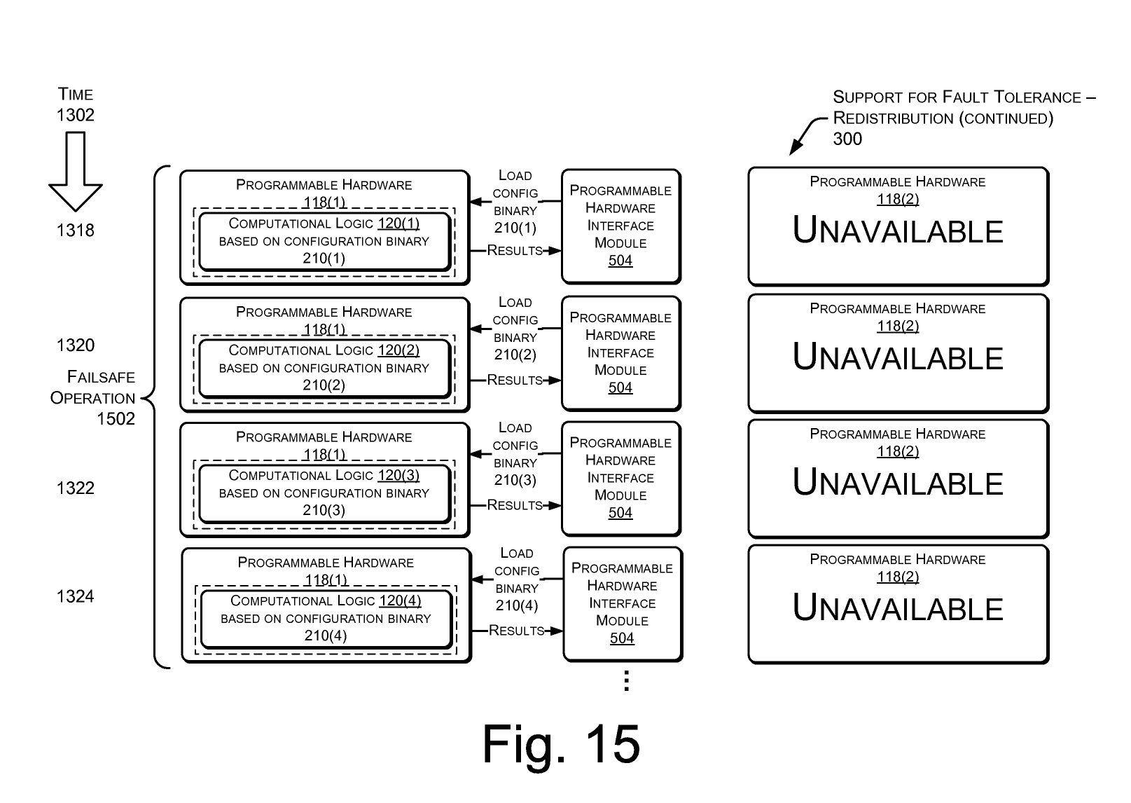

Continuing the flow of the diagram to FIG. 15, failsafe operation 1502 is shown. Programmable hardware 118(2) remains unavailable, and programmable hardware 118(1) handles execution of the configuration binaries listed in execution sequence 508. At 1318, programmable hardware 118(1) loads and executes configuration binary 210(1) which is next in execution sequence 508. At 1320, programmable hardware 118(1) loads and executes configuration binary 210(2), while at 1322 configuration binary 210(3) is loaded and executed, and at 1324 configuration binary 210(4) is loaded and executed. Thus, the list present in execution sequence 508 has been completely executed, and may continue as called for by the execution sequence 508. While execution performance has decreased due the loss of programmable hardware 118(2), processing of the reg exs 108(1)-(R) was still able to continue. Because configurations are virtual, this dynamic redistribution becomes possible. Returning to our example of spam filtering, the failure of programmable hardware 118(2) simply degraded performance of the spam filtering, rather than resulting in the system being completely disabled.

In some implementations having multiple pieces of programmable hardware 118, configuration binaries may be under-allocated to allow for failure. For example, an execution sequence in each programmable hardware device may include an idle placeholder, which may then be consumed during a failure.

### Fault Tolerance Through Sparing

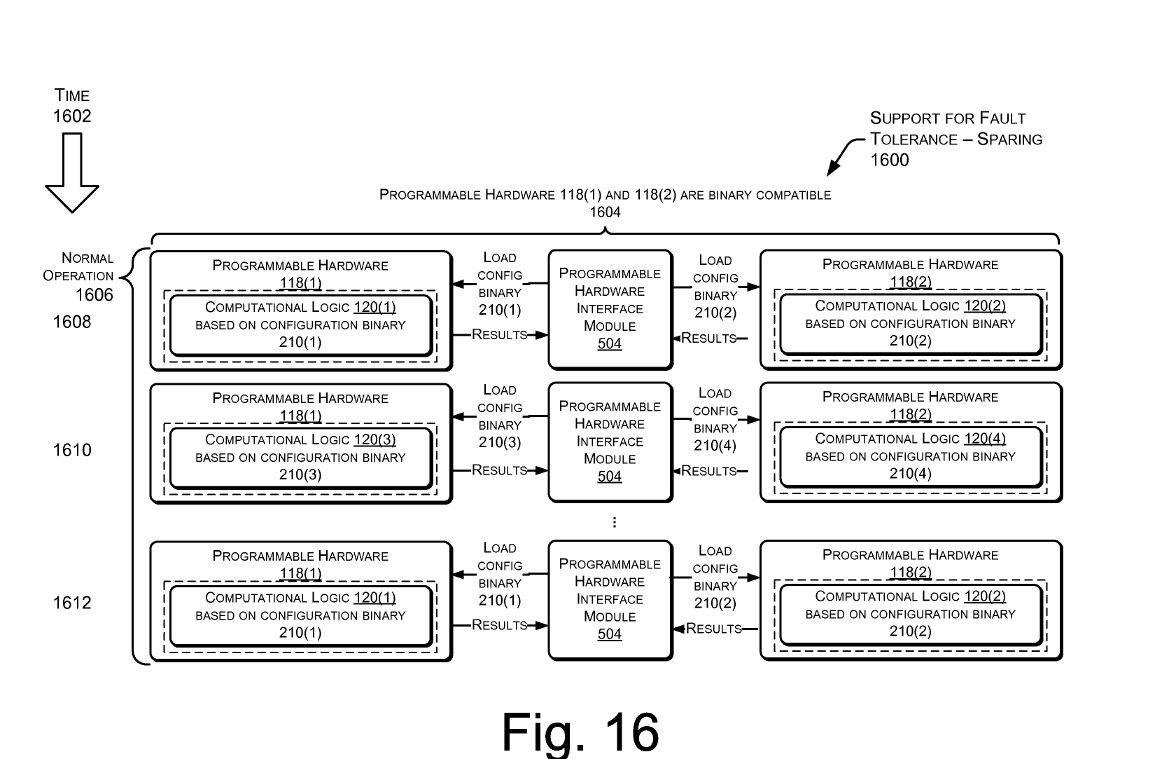

FIGS. 16-18 comprise a flow diagram 1600 illustrating support for fault tolerance through the use of a spare functional programmable hardware device. As above, in these diagrams, time increases down the page, as indicated by arrow 1602.

Beginning with FIG. 16, the PHIM 504 is shown coupled to two programmable hardware devices, 118(1) and 118(2). As above, for this example, assume programmable hardware 118(1) and 118(2) are binary compatible 1604, that is, the same configuration binary 210 may be executed on either without recompilation. Also assume that execution sequence 508 is for configuration binary 210(1), (2), (3), (4), (1), (2), (3), (4), and so on.

FIG. 16 shows normal operation 1606. During normal operation 1606, at 1608 PHIM 504 loads configuration binaries 210(1) and (2) into programmable hardware 118(1) and (2), respectively. The resulting computational logic 120(1) and (2) run, and results are returned to PHIM 504. Likewise, at 1610, configuration binaries 210(3) and (4) are loaded and executed. At 1612, the sequence repeats, loading configuration binaries 210(1) and (2) for processing.

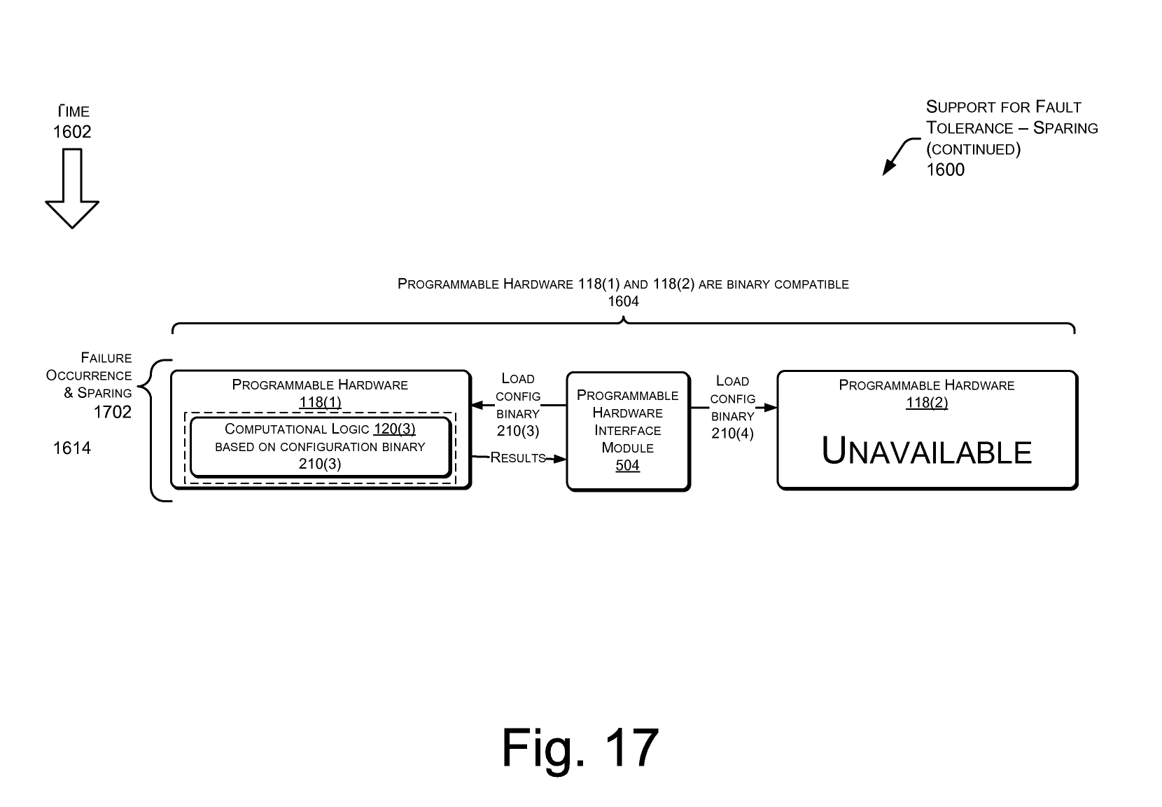

FIG. 17 continues flow 1600 and depicts failure occurrence and sparing at 1702. In this illustration, at 1614 programmable hardware 118(1) has successfully loaded configuration binary 210(3), while programmable hardware 118(2) has become unavailable to load configuration binary 210(4). Upon determining programmable hardware 118(2) has failed, PHIM 504 may redirect configuration binary 210(4) to a spare programmable hardware device 118(3) which has been held in reserve.

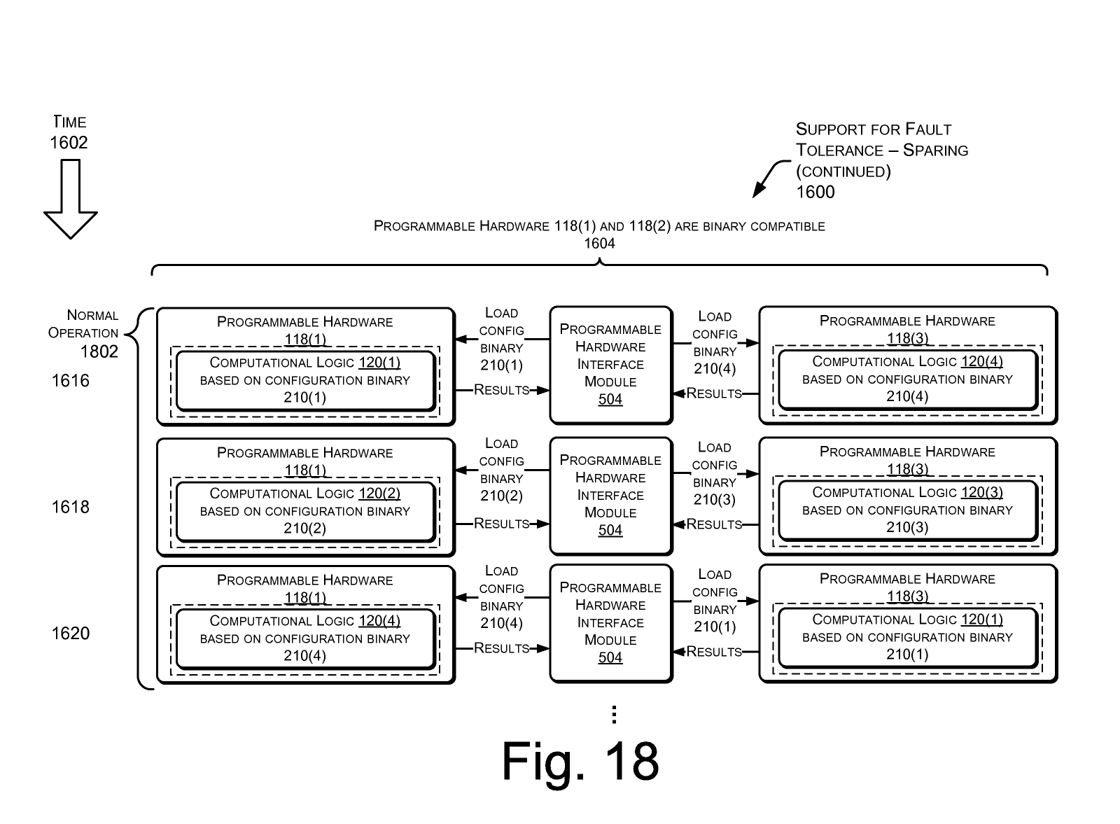

FIG. 18 illustrates the resumption of normal operation 1802 by redirection of a configuration binary to the spare programmable hardware. At 1616, programmable hardware 118(1) has loaded configuration binary 210(1) while spare programmable hardware 118(3) has loaded configuration binary 210(4).

At 1618, PHIM 504 continues to load and execute configuration binaries as designated in the execution sequence 508. Thus configuration binaries 210(2) and 210(3) and loaded into programmable hardware 118(1) and 118(3), respectively. At 1620, the configuration binaries 210(4) and 210(1) are loaded into programmable hardware 118(1) and 118(3) respectively, beginning the execution sequence 508 again.

Sparing in the context of programmable hardware 118 offers several advantages. Because the configuration binaries encapsulate a complete configuration, they may be quickly loaded and unloaded into programmable hardware. This is in contrast to the operational complexity and time required to bring up a server instance. Thus, spare programmable hardware may be accessed and brought into service very quickly.

### Fragmentation Mitigation

As mentioned above, over time the list of regular expressions to be processed changes. In our example of spam filtering, new reg exs are added while others are removed. FIG. 19 is a schematic 1900 illustrating fragmentation mitigation of regular expressions across configuration binaries. In one implementation, fragmentation mitigation may be performed within PHSC 114.

This addition and subtraction over time leads to fragmentation of “live” or still required reg exs among those which have been discarded. At 1902, several fragmented configuration binaries are shown before fragmentation mitigation. In this figure, crosshatching indicates an unused/canceled reg ex 1904. In this example, reg exs 108(1), (3), (5), (7), and (9) have been cancelled. For example, these might relate to spam filters for “credit card” and variants, which are now removed from the spam list due to the company's new credit card business. Reg exs 108(2), (4), (6), and (8) remain in use. This has left the four configuration binaries 210(20)-(23) containing those reg exs fragmented, with a few desired reg exs interspersed with several unused reg exs. Execution of these fragmented configuration binaries wastes available programmable hardware resources. Thus it is desirable to mitigate this fragmentation.

At 1906, newly added reg ex 108(10) executes in auxiliary reg ex processing module 124. During the next round of compilation of configuration binaries, when space if available within the configuration binaries, reg ex 108(10) may be transferred from execution in processing module 124 to a configuration binary 210 to run on programmable hardware 118.

At 1908, configuration binaries after fragmentation mitigation are shown. Unused reg exs have been discarded, and at 1910 those reg exs which were still in use as well as reg ex 108(10) have been compiled into two new configuration binaries. Where four configuration binaries were being executed with one reg ex executing in software, now two configuration binaries execute.

FIG. 19 depicts the complete recompilation of all active reg exs 108. However, compilation is expensive in terms of time and system resources. In some implementations, it may be desirable to selectively recompile to minimize system costs, while performing complete recompilation less frequently.

FIG. 20 is a schematic 2000 illustrating fragmentation mitigation by selective recompilation. A determination as to whether to selectively or completely recompile involves weighing the potential execution efficiency of the hardware and software against the compilation time.

At 2002, configuration binaries 210(30)-(33) are shown before fragmentation mitigation. As above, unused or cancelled reg exs are indicated with a crosshatch 2004. In this example, reg exs 108(1), (3), (5), (7), and (9) have been cancelled. Reg exs 108(2), 108(4), 108(6), and 108(8) remain in use. At 2006, newly added reg ex 108(10) executes in auxiliary reg ex processing module 124 while awaiting the next compilation of configuration binaries.

In this illustration, assume that the weighing of potential execution efficiency of the hardware and software against the compilation time results in resources for one recompilation being available. Resource estimation information generated during the initial compilation is retrieved and the configuration binaries are sorted from most unused space to least unused space. Configuration binary 210(30) has 100% unused space, configuration binary 210(31) has about 66% unused space, configuration binary 210(32) has about 55% unused space and configuration binary 210(33) has about 33% unused space.

In one implementation, selective recompilation may involve moving reg ex 108(1) which is being executed by auxiliary reg ex processing module 124 into hardware, then moving reg exs to configuration binaries with the most unused space. In this illustration, configuration binaries 210(30) and (31) are selected for selective recompilation, as indicated by broken line 2008.

Active reg exs are combined until N configurations (in this case N=1 because one compilation is available) have been filled. In this illustration, configuration binary 210(30) is discarded as it is empty, while reg ex 108(2) in configuration binary 210(31) is combined with reg exs 108(2) and (10) at 2010 to produce configuration binary 210(34). At 2012, the results after selective fragmentation migration are depicted, showing newly compiled configuration binary 210(34) and unchanged configuration binaries 210(32) and (33). This reduces the number of software-based reg ex to 0, and the number of total hardware configurations from four to three. Thus, minimal compilation resources have been used, while reducing overall fragmentation.

### Prioritization of Tasks, and Resource Reclamation

In some implementations, it may be beneficial to prioritize tasks. For example, today's spam may predominately feature “credit card” advertisements, thus reg exs designed to find this phrase may be given a higher priority in order to quickly remove these prevalent occurrences.

FIG. 21 is a schematic 2100 illustrating priority-aware hardware assignment of regular expressions, as well as the packing and scheduling of those regular expressions into configuration binaries. In this illustration, normal priority reg exs are designated with white, middle priority reg exs are designated with diagonal lines, while highest priority reg exs are shaded. At 2102 regular expressions for execution are shown. Among these, reg exs 108(1), (6), and (8) are highest priority. Reg ex 108(5) is designed as medium priority, while the remainder 108(2), (3), (4), (7), (9), and (10) are normal priority.

At 2104 reg exs which have been packed, compiled, and sequenced for execution are shown. Those reg exs having higher priority have been packed together, and, in some implementations, may be designed for execution on faster programmable hardware devices 118, receive priority in the execution sequence 508, or be placed at multiple points in the execution sequence 508 for more frequent execution. As shown, configuration binary 210(41) has sufficient capacity for all of the high priority reg exs. Configuration binary 210(42) includes medium priority reg ex 108(5) and also includes normal priority 108(4) because there was additional capacity remaining for use. Configuration binaries 210(41) and (42) together may be designated as shown by 2106 for execution on faster programmable hardware given their higher priority contents. Configuration binaries 210(43) and (44) which include normal priority reg exs may be designated 2108 for execution on slower programmable hardware devices.

Packing of configuration binaries and/or priority assignment of execution sequence for configuration binaries may be made such that certain tasks are executed first allowing their results to affect later processing or eliminate later processing altogether. For example, the reg ex looking for “zero down home mortgage financing bonanza” may be given priority over the reg ex for “home mortgage” given the combination of terms in the first may serve to more readily identify spam messages.

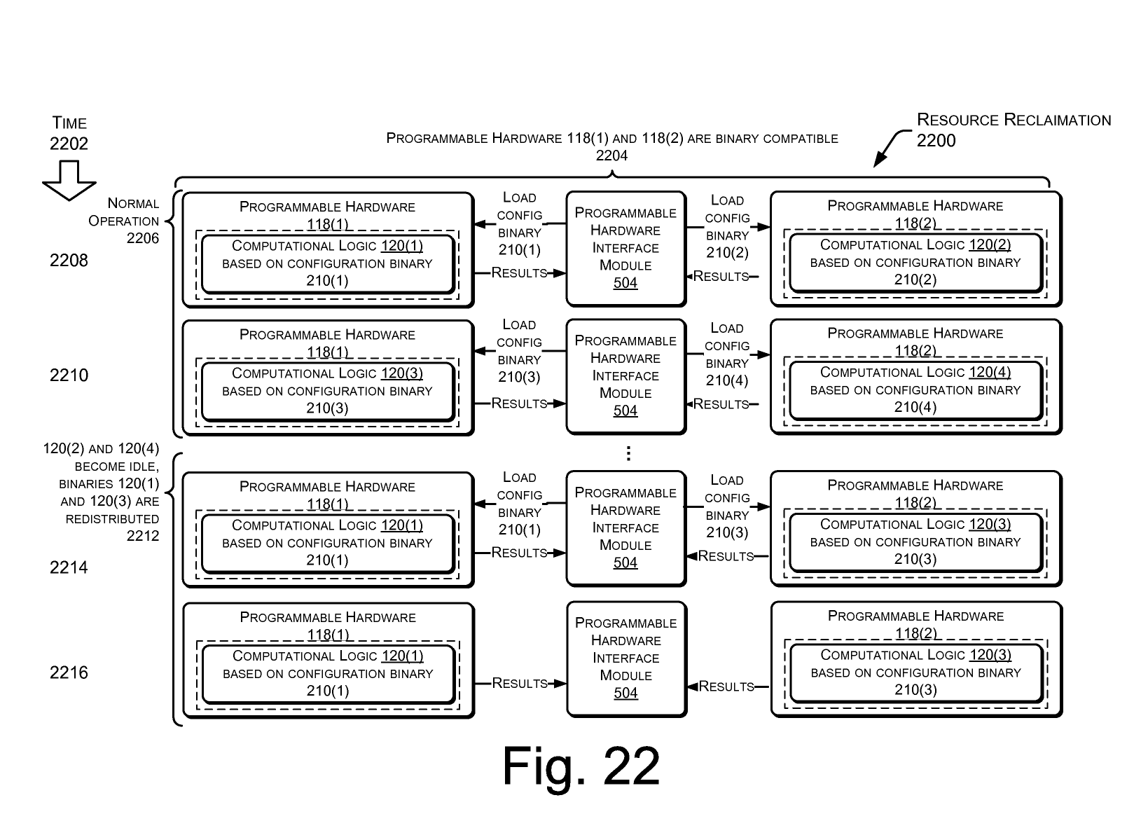

FIG. 22 is a flow diagram 2200 illustrating reclamation of idle programmable hardware resources by redistributing execution of configuration binaries. As above, in this illustration, time increases down the page, as indicated by arrow 2202.

For this example, assume programmable hardware 118(1) and 118(2) are binary compatible 2204, that is, the same configuration binary 210 may be executed on either without recompilation. Also assume that an initial execution sequence 508 is for configuration binary 210(1), (2), (3), (4), (1), (2), (3), (4), and so on.

At 2206 normal operation is depicted. At 2208, PHIM 504 loads configuration binaries 210(1) and (2) into programmable hardware 118(1) and (2), respectively. Results are returned, and at 2210 PHIM 504 loads configuration binaries 210(3) and (4) into programmable hardware 118(1) and (2). This process may continue on, continuing to run through the initial execution sequence 508.

However, suppose computational logics 120(2) and (4) based on configuration binaries 210(2) and (4), respectively, are idle. Perhaps they have been suspended, or completed before computational logics 120(1) and (3). Were the initial execution sequence to continue uninterrupted, programmable hardware resources would be wasted waiting for these idle configuration binaries or executing the suspended configuration binaries. Thus, in this example, the initial execution sequence is modified to reclaim resources.

At 2212, reclamation of this idle time is shown through the redistribution of those configuration binaries which are still active. Thus, at 2214, PHIM 504 loads configuration binary 210(1) and (3) into programmable hardware 118(1) and (2), respectively. At 2216, programmable hardware 118(1) and (2) run computational logic 120(1) and (3) which are based on configuration binaries 210(1) and (3) again. Because computational logics 120(2) and 120(4) are idle, they are not loaded and run. Thus, the computational logics still designated for running such as 120(1) and (3) may continue to execute unimpeded by idle or suspended computational logics.

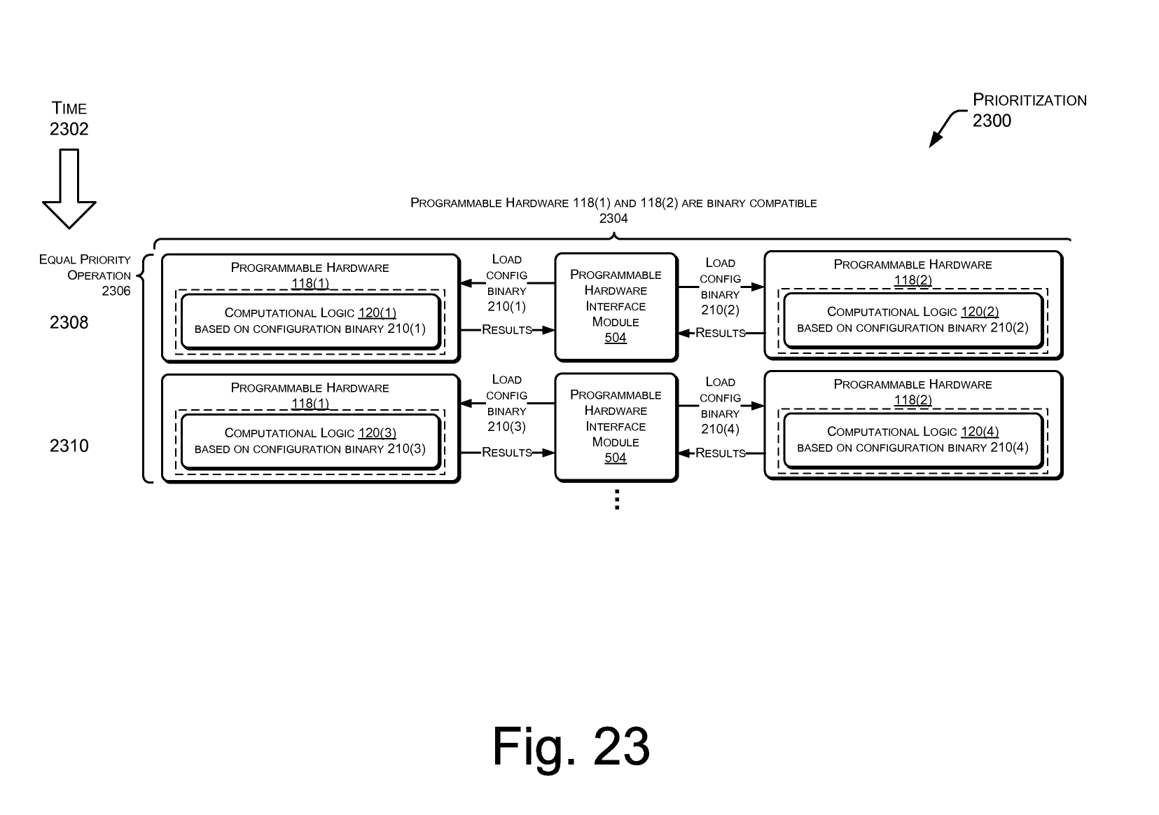

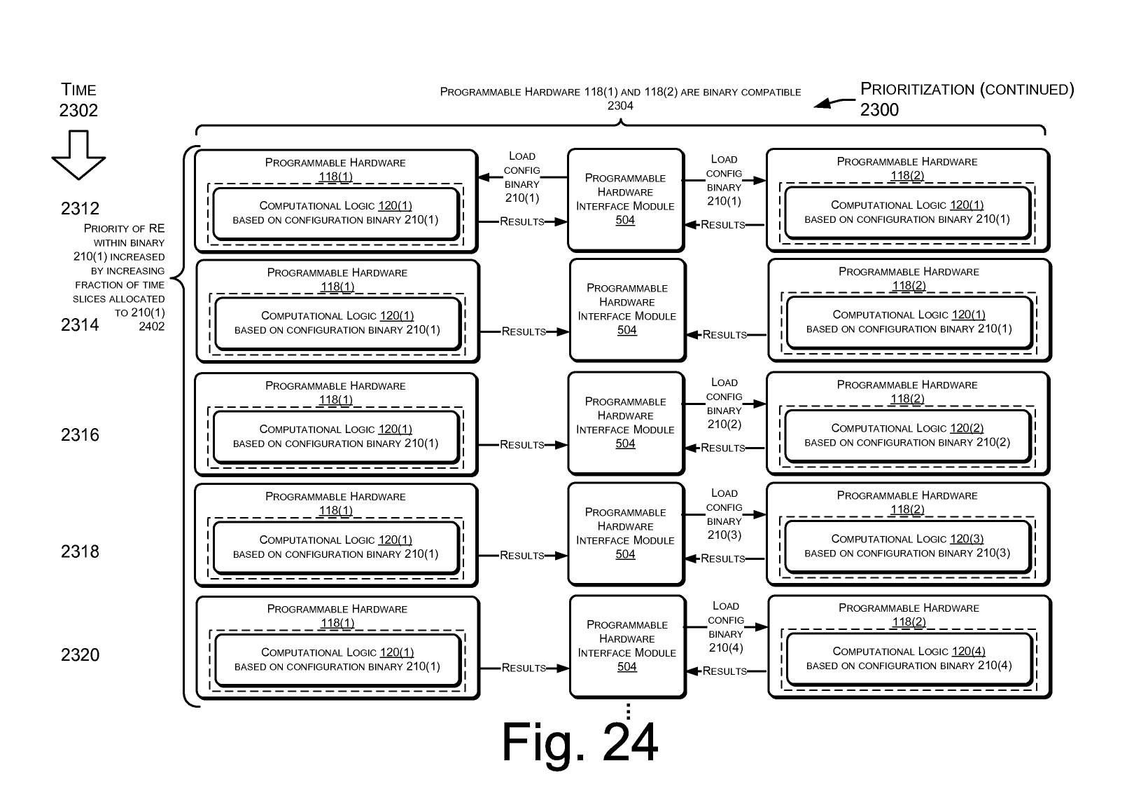

As mentioned above, when particular reg exs are more important than others, they can be given more resources. FIGS. 23-24 are a flow diagram 2300 illustrating prioritization of configuration binaries and the regular expressions within. In this illustration, time increases down the page, as indicated by arrow 2302. Assume programmable hardware 118(1) and (2) are binary compatible 2304.

Beginning on FIG. 23, at 2306 equal priority operation is depicted. No task within any computational logic is given priority. The execution sequence 508 is for configuration binary 210(1), (2), (3), (4), (1), (2), (3), (4), and so on. At 2308 configuration binaries 210(1) and (2) are loaded onto programmable hardware 118(1) and (2), respectively, for running. At 2310, configuration binaries 210(3) and 210(4) are loaded onto programmable hardware 118(1) and (2), respectively for running.

Continuing the flow to FIG. 24, at 2402 a reg ex within configuration binary 210(1) has been given a high priority and its fraction of time slices for execution have been increased. The execution sequence 508 is thus altered to execution configuration binary 210(1), (1), (1), (1), (1), (2), (1), (3), (1), (4). Thus at 2312 configuration binary 210(1) is loaded onto both programmable hardware 118(1) and 118(2). At 2314 no configuration binaries are loaded as computational logic 120(1) on both programmable hardware devices is already present and the computational logic is run again.

At 2316, computational logic 120(1) runs again on 118(1) while configuration binary 210(2) is loaded onto programmable hardware 118(2) and run. At 2318, computational logic 120(1) runs again, while configuration binary 210(3) is loaded and run on programmable hardware 118(2). At 2320, computational logic 120(1) runs again, while configuration binary 210(4) is loaded by PHIM 504 into programmable hardware 118(2). Thus, in this example, the high-priority reg ex contained within configuration binary 210(1) has been executed 70% of the time.

### Merging of Tasks

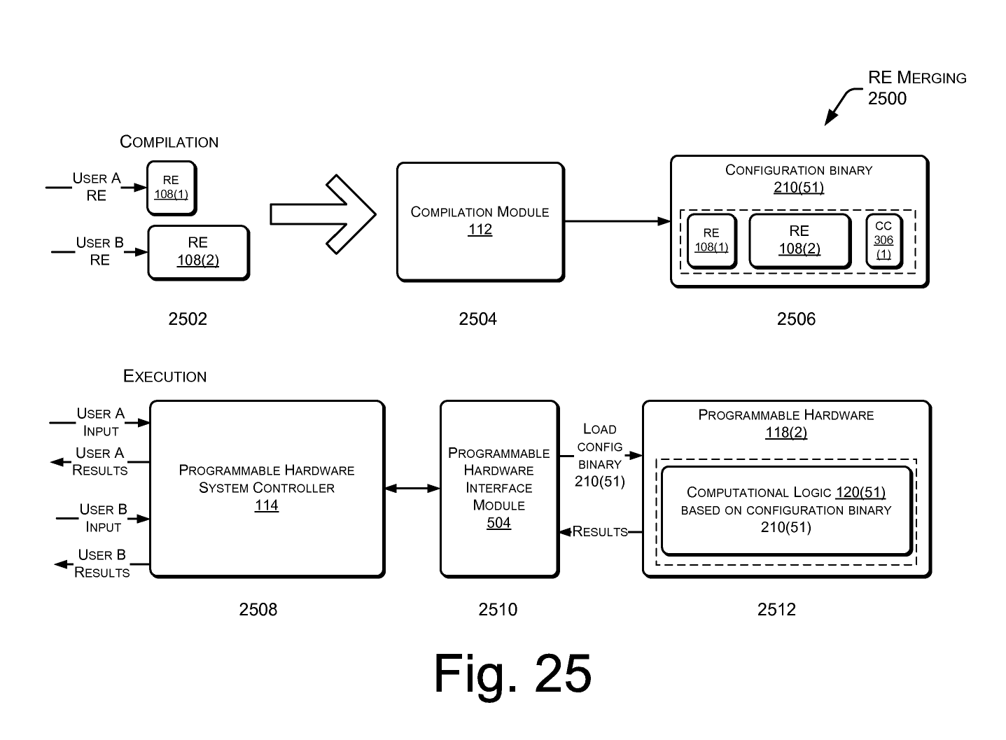

During operation of the regular expression processing system 102, reg exs from multiple users and/or applications may be received. For example, a spam filtering system may receive multiple streams of strings to indicate spam, such as those flagged by users or analytical software. FIG. 25 is a flow diagram 2500 illustrating merger of regular expressions by multiple users/applications at compilation and/or execution. Such merging increases speed by minimizing reconfiguration of the programmable hardware, which is relatively expensive in terms of time and system resources.

During compilation merging, at 2502 reg ex 108(1) is received from user A while reg ex 108(2) is received from user B. At 2504, the compilation module 112 processes these reg exs, determines they may both run in the same configuration binary, and at 2506 produces configuration binary 210(51) which includes reg exs 108(1) and (2). At 2508, inputs from user's A and B are received at PHSC 114. At 2510, the PHIM 504 loads configuration binary 210(51) for execution, while at 2512 the programmable hardware executes the configuration binary and provides results back to the PHIM 504. In turn, the PHSC 114 provides results back to the respective users. Among other benefits, merging eliminates the need for a context switch. For example, without merging it would be necessary to switch contexts between user A and user B. Thus user A's reg ex 108(1) would be executing while reg ex 108(2) waits. Upon completion of reg ex 108(1), reg ex 108(2) would execute. With merging, both may execute simultaneously.

Security in this process is maintained during merging because only the underlying compilation module 112 and the PHSC 114 are even aware that these two different reg exs were executed simultaneously. User A and User B are unaware of the merger, and their respective results remain separate.

### Delayed Configuration Paging

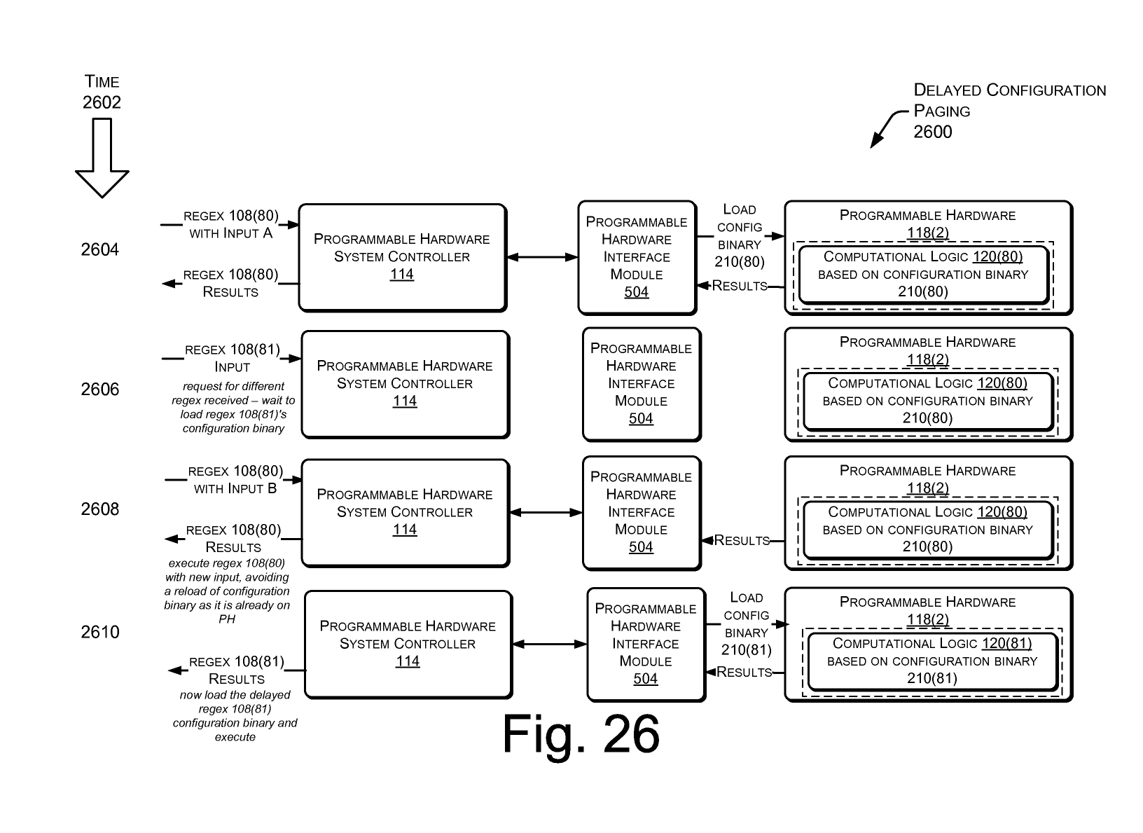

In addition to merging, multiple applications or users may share resources during operation of regular expression processing system 102. FIG. 26 is a flow diagram 2600 illustrating delayed configuration paging of configuration binaries to facilitate this sharing. Delayed paging allows for the delay of tasks to allow consolidation of those tasks and minimize reconfigurations of the programmable hardware.

In this illustration, time increases down the page, as indicated by arrow 2602. At 2604, PHSC 114 receives reg ex 108(80) with input A, such as a first portion of a corpus. PHSC 114 passes the reg ex along to PHIM 504 for execution on programmable hardware 118(2), and returns the results to the user.

At 2606, PHSC 114 receives reg ex 108(81) for processing. However, it has been anticipated that additional processing for reg ex 108(80) will be occurring. As a result, the processing of reg ex 108(81) is delayed.

At 2608, reg ex 108(80) is again requested, this time with input B, such as a second portion of the corpus. Because programmable hardware 118(2) already has configuration 210(80) which incorporates reg ex 108(80) loaded, there is no delay for reconfiguration, and processing may commence. These results are then returned to the user.

At 2610, reg ex 108(80) has been completed, and reg ex 108(81) which was delayed, may now be loaded and executed by programmable hardware 118(2). These results may then be returned to the user.

Thus, in some implementations, work may be stored for a configuration binary 210 which is not currently loaded, and executed out-of-order, relative to the order in which it was received. This may allow greater efficiency by minimizing the number and frequency of configuration binary 210 loads into programmable hardware 118.

### Sub-Binary Compilation

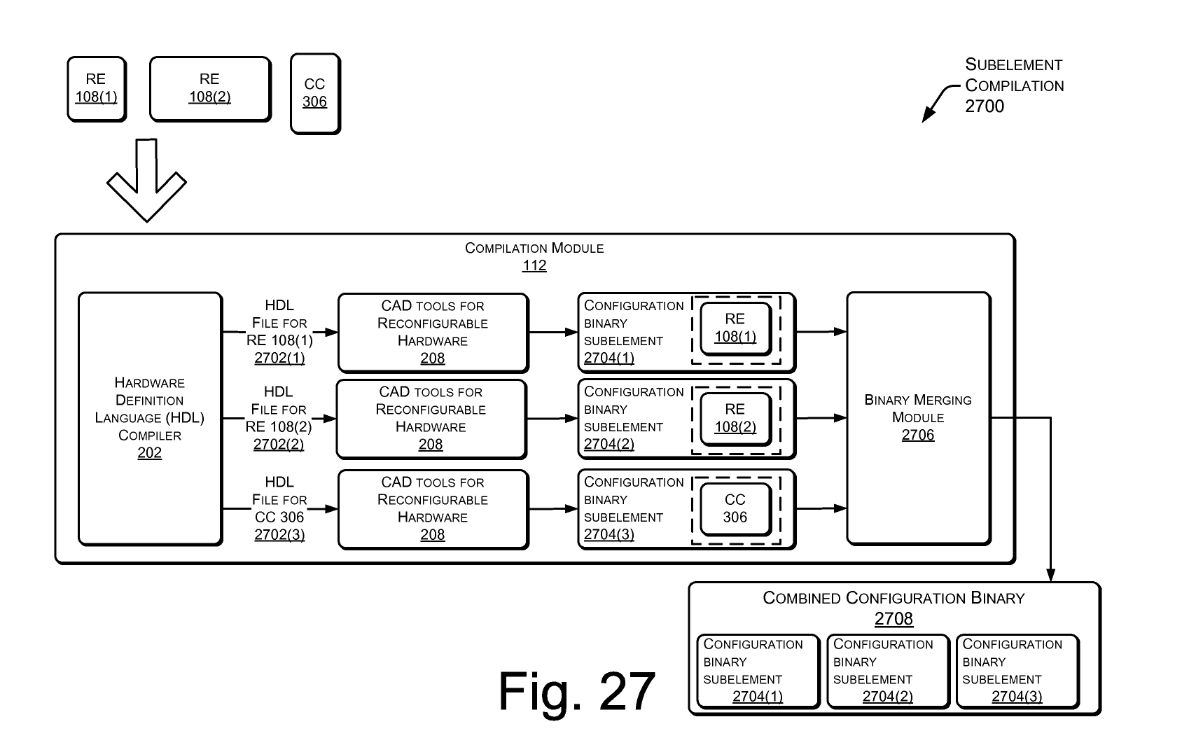

Compilation may occur at levels of granularity below that of an entire configuration binary designed to utilize programmable hardware 118. Some reconfigurable hardware devices allow for partial dynamic reconfiguration, that is, a reconfiguration at a granularity less than the entire device. FIG. 27 is a flow diagram 2700 illustrating compilation of configuration binary subelements, which may then be combined to create a complete configuration binary.

The execution time required by CAD tools for programmable hardware 208 increases super-linearly with the size of the computational logic 120. Because of this, performance advantages may be realized by splitting a larger configuration binary or HDL file into smaller pieces, or subelements, and compile those smaller pieces separately. The resulting subelements may then be combined to form a full computational logic. In addition to faster CAD tool 208 compilation time, binaries would be easier to defragment and reconfigure due to the ability to manipulate these pre-configured subelements rather than having to recompile an entire configuration binary which is resource and time intensive. Packing of these subelements may to be done dynamically (not statically once for the entire configuration).

In this illustration, regular expressions 108(1) and 108(2) and communication and control logic (CC) 306 are received by compilation module 112 which has been configured for sub-element compilation. HDL compiler 202 creates HDL files for each. Thus, HDL file 2702(1) for RE 108(1), HDL file 2702(2) for RE 108(2), and HDL file 2702(3) for RE 108(3) are compiled. CAD tools 208 accepts these HDL files 2702(1)-(3) for creation of subelements. Reg ex 108(1) results in configuration binary subelement 2704(1), reg ex 108(2) results in configuration binary subelement 2704(2), and CC 306 results in configuration binary subelement 2704(3).

Binary subelements may be selected for execution, and binary merging module 2706 may stitch together these subelements to produce combined configuration binary 2708. This combined configuration binary 2708 may then be loaded and executed by programmable hardware 118.

### Combining Computation and Supersetting

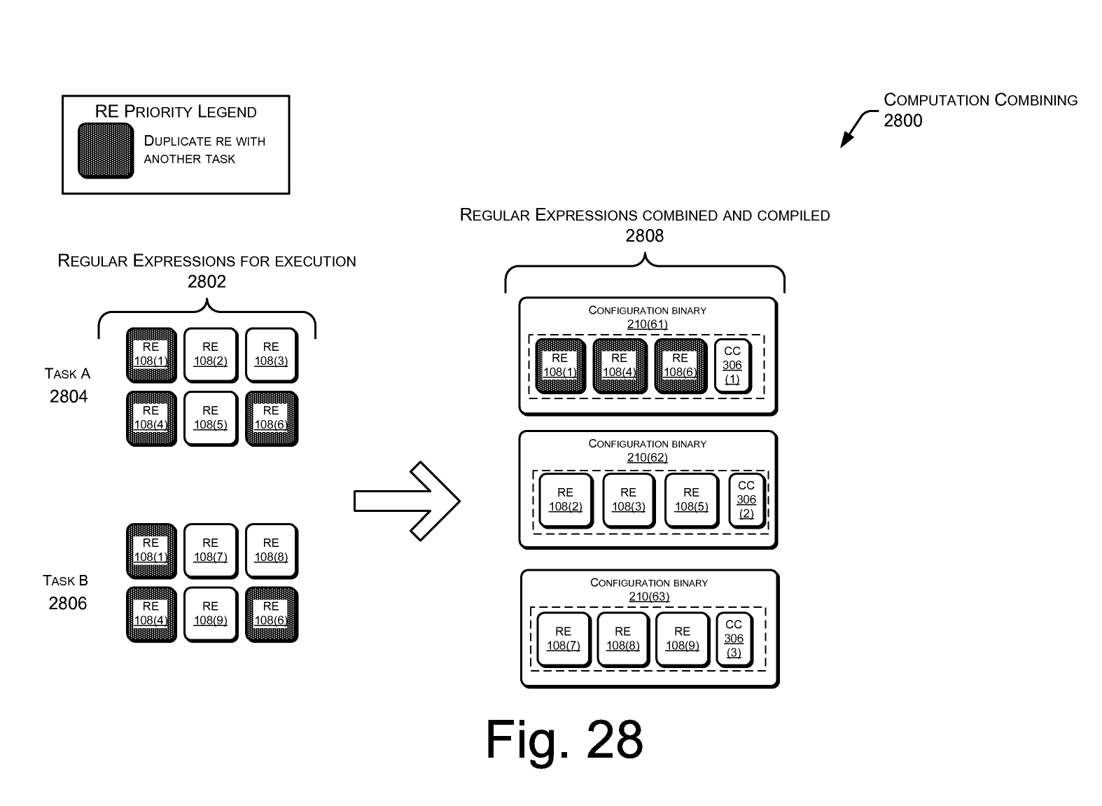

Additional performance benefits may be achieved through combination of computations and supersetting. FIG. 28 is a schematic 2800 illustrating computation combining of regular expressions. Computations such as reg exs which are similar or duplicative may be combined. For example, suppose several spam filtering applications and users submit groups of reg exs for processing. Within these groups there may be duplicates which may be found and packed for common execution.

At 2802, regular expressions for execution are shown. These include task A at 2804 which includes reg exs 108(1)-(6). Also included in the reg exs for execution are Task B at 2806 which includes reg exs 108(1), (4), (6), (7), (8), and (9). Duplicate reg exs are shown with shading. Reg exs 108(1), (4), and (6) are common between the two tasks. Without computational combining, four configuration binaries would have been necessary to encompass all twelve reg exs.

However, through computational combining this number may be reduced to three configuration binaries. At 2808, reg exs which have been combined and compiled are shown. Configuration binary 210(61) includes reg exs 108(1), (4), and (6), while configuration binaries 210(62) and 210(63) incorporate the remaining regular expressions, without duplicates. An additional benefit is that when switching between task A 2804 and task B 2806, one reconfiguration is necessary rather than four.

FIG. 29 is a schematic 2900 illustrating supersetting of regular expressions which have duplicative or similar portions. As above, duplicate or similar portions of a reg ex are shown with shading. At 2902, regular expressions for execution are shown. Reg exs 108(1), (2), and (3) are waiting for execution. As shown here, a portion of reg ex 108(2) is similar to reg ex 108(1). For example, suppose reg ex 108(1) is for the string “home mortgage” while reg ex 108(2) is for the string “refinancing and equity from your home mortgage.” Thus, 108(2) contains a portion similar to 108(1), that of the string “home mortgage,” which is indicated with shading.

During compilation by compilation module 112, the similar or identical portions may be combined. At 2904, a superset of regular expressions which have been packed and compiled is shown. Within configuration binary 210(71) reg ex 108(2), along with the portion common to 108(1), 108(3) and CC 306(1) are shown. Reg ex 108(1) is not included in the configuration binary 210(71) as the same work will be done by the common portion in reg ex 108(2). After execution. PHSC 114 may separate out the results, and provide them back as if 108(1) had been executed separately in programmable hardware.

Supersetting allows a reduction in the computational resources necessary for execution. Supersetting also reduces the need for reconfiguration, by allowing more equivalent regular expressions to be performed with fewer configuration binaries.

Dealing with Heterogeneous FPGAS

Programmable hardware 118 in the system 102 does not have to be identical, or even be bitstream-compatible. The system 102 may include devices of different size, speed, grade, manufacturer, onboard memory capacity, etc. Where heterogeneous hardware is present, a programmable hardware device 118 may be targeted for use depending on an existing reg ex distribution and device work load (some devices may be used less than others), and reg ex priority.

The choice of target programmable hardware 118 will affect several factors. These factors include variations in estimation of resource requirements based on different hardware. For example, one manufacturer may use different basic logic elements than another, resulting in variations in how reg exs are implemented in the programmable hardware 118.

Another factor affected by the choice of target programmable hardware 118 is packing capability. Packing capability reflects the capacity of the programmable hardware 118. For example, a larger device can hold more reg exs than a smaller device. This affects where and how a reg ex may be split across multiple configurations.

Feasibility for mapping a partial reg ex may also be affected during the determination of target programmable hardware. For example, in some situations where the size of the intermediate data is on the same order of magnitude as the input corpus data, onboard memory may be beneficial to performance. In these situations, the determination of target programmable hardware may consider the feasibility for the hardware to handle it.

Operation of the system controller is affected as well by the target programmable hardware, given that different devices may be controlled with different commands. Finally, “portability” of the virtualization is affected due to differences in target hardware. For example, in terms of quickly adjusting fault tolerance such as during sparing or redistribution, a reg ex originally allocated to a failed device can migrate to other bitstream-compatible programmable hardware devices 118 without recompilation.

### Configuration Prefetching/Paging

When multiple applications or users share the same physical platform, calls for specific configuration binaries 210 or subelements may be anticipated. Thus configuration binaries may be pre-loaded in a fashion similar to memory pre-fetching and speculative execution.

Direct Communication with the FPGA

As mentioned earlier, in some implementations PHSC 114 may handle scheduling and data flow to and from the user. Programmable hardware 118 could then include the capability to handle input data replaying, output data reordering, reconfiguration sequencing, and so forth. Programmable hardware 118 in this implementation may require additional external memory to store state information.

In another implementation, programmable hardware 118 may itself handle receiving the input data initially. In this implementation, the programmable hardware 118 would receive the input data and start performing the searching with the currently loaded computational logic 120. Programmable hardware 118 would relay the input data back to the part of the PHSC 114 running in software. This software-based part of the PHSC 114 would be responsible for replaying the data, reordering the output data and reconfiguring the programmable hardware 118.

### CONCLUSION

Although specific details of illustrative methods are described with regard to the figures and other flow diagrams presented herein, it should be understood that certain acts shown in the figures need not be performed in the order described, and may be modified, and/or may be omitted entirely, depending on the circumstances. As described in this application, modules and engines may be implemented using software, hardware, firmware, or a combination of these. Moreover, the acts and methods described may be implemented by a computer, processor or other computing device based on instructions stored on memory, the memory comprising one or more computer-readable storage media (CRSM).

The CRSM may be any available physical media accessible by a computing device to implement the instructions stored thereon. CRSM may include, but is not limited to, random access memory (RAM), read-only memory (ROM), electrically erasable programmable read-only memory (EEPROM), flash memory or other solid-state memory technology, compact disk read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by a computing device.

What is claimed is:

1. One or more computer-readable storage media storing instructions that, when executed by a processor cause the processor to perform acts comprising:
parsing a list of regular expressions and translating the list of regular expressions into corresponding logic and state equations (902);
estimating physical resource requirements to implement the logic and state equations on a programmable hardware device (904);
distributing the logic and state equations into sets, the distributing based on the estimated physical resource requirements, wherein each set is sized to fit within the programmable hardware device when joined with control and communication logic (906);
adding the control and communication logic to each set (908);
generating a hardware definition language (HDL) file for each set (910); and
generating a configuration binary from each HDL file (914), wherein each configuration binary is configured to execute on the programmable hardware device.

2. The computer-readable storage media of claim 1, further comprising generating a configuration specification for one or more of the sets (912).

3. The computer-readable storage media of claim 1, further comprising:
loading the configuration binary into the programmable hardware device to generate computational logic (1104);
loading at least a portion of a corpus into the programmable hardware device (1106); and
executing the computational logic on the programmable hardware device against the loaded corpus (1108).

4. The computer-readable storage media of claim 1, wherein the estimating physical resource requirements comprises:
associating a particular regular expression with computational logic on the programmable hardware device (1002);
identifying and removing redundant logic from within the computational logic (1004) to form consolidated logic;
estimating local storage requirements of the consolidated logic (1006) on the programmable hardware device; and
applying a computer-aided-design-tool specific correction factor (1008) to the consolidated logic and local storage requirements; and
generating an estimated physical resource requirement based on the estimated consolidated logic and local storage requirements.

5. The computer-readable storage media of claim 1, further comprising:
adding a regular expression on the list to a discard list (1210); and
discarding an execution result associated with the regular expression on the discard list (1212).

6. The computer-readable storage media of claim 3, further comprising patching execution results with additional regular expressions not included in the list of regular expressions represented by corresponding logic and state equations (1214).

7. The computer-readable storage media of claim 3, further comprising dynamically redirecting the loading of configuration binaries from an unavailable programmable hardware device to an available programmable hardware device (1402).

8. The computer-readable storage media of claim 1, further comprising:
removing computational logic associated with a discarded regular expression from the set (1902); and
re-distributing remaining computational logic and control and communication logic into a new set or sets (1908).

9. The computer-readable storage media of claim 1, wherein the configuration binary comprises a plurality of configuration binary subelements (2700).

10. A method comprising:
generating on a processor logic and state information suitable for execution on a programmable hardware device, wherein the execution results in processing a plurality of tasks;
estimating hardware capacity required by the programmable hardware device to process the logic and state information; and
distributing, based on the estimated hardware capacity requirements, the logic and state information into sets, such that the logic and state information of each set fits within a hardware capacity of the programmable hardware device.

11. The method of claim 10, further comprising generating for each set a configuration binary configured to execute on the programmable hardware device.

12. The method of claim 11, further comprising generating a configuration specification based on the configuration binary.

13. The method of claim 10, further comprising adding control and communication logic to each set.

14. The method of claim 11, further comprising loading the configuration binary onto a programmable hardware device.

15. The method of claim 10, wherein the tasks are regular expressions executed against a corpus.

16. The method of claim 10, wherein the generating, estimating, and distributing occurs automatically.

17. The method of claim 10, further comprising:
determining an execution priority of the sets on the programmable hardware device, wherein the execution priority includes high priority tasks and low priority tasks; and
sequencing for execution the sets containing high priority tasks on programmable hardware faster than programmable hardware which executes lower priority tasks.

18. The method of claim 10, further comprising:
sequencing tasks for execution on the programmable hardware device by a priority level; and
distributing the tasks among sets such that high priority tasks are distributed to sets which are executed first or more frequently than low priority sets.

19. A system comprising:
a processor;
a memory coupled to the processor;
a user interface stored in the memory and configured to execute on the processor;
a plurality of tasks obtained through the user interface and stored in the memory;
a compilation module stored in memory and configured to:
translate at least a portion of the plurality of tasks into corresponding logic and state equations;
estimate physical resource requirements to implement the logic and state equations on a programmable hardware device;
distribute the logic and state equations into sets based on the estimated physical resource requirements, wherein each set is sized to fit within the programmable hardware device when joined with control and communication logic; and
generate a configuration binary for each set; and
a programmable hardware system controller configured to execute on the processor to manage the configuration and input/output data marshalling for the programmable hardware device.

20. The system of claim 19, wherein the plurality of tasks obtained by the user interface and stored in memory are regular expressions configured to execute against a corpus of data.
